(19) United States
(12) Patent Application Publication
(10) Pub. No.: US 2026/0237006 A1
(43) Pub. Date: Aug. 13, 2026

(54) IMAGE DISPLAY SYSTEM, AUTOMATIC CALCULATION SYSTEM, IMAGE DISPLAY METHOD, AND AUTOMATIC CALCULATION METHOD

(71) Applicant: H2Corporation, Tokyo (JP)

(72) Inventors: Hirotsugu Kawashima, Tokyo (JP); Tung Nguyen, Tokyo (JP); Tuan Anh Nguyen, Tokyo (JP); Duc Nam Tran, Tokyo (JP); Hoang Ha Nguyen, Tokyo (JP); Anh Tuan Nguyen, Tokyo (JP)

(73) Assignee: H2Corporation, Tokyo (JP)

(21) Appl. No.: 19/348,700

(22) Filed: Oct. 2, 2025

(30) Foreign Application Priority Data
Feb. 7, 2025 (JP) 2025-019376

(51) Int. Cl. G06Q 50/08; G06V 30/10; G06V 30/418; G06V 30/422

(52) U.S. Cl. CPC G06Q 50/08; G06V 30/10; G06V 30/418; G06V 30/422

(57) ABSTRACT

[Problem to be Solved] To provide an image display system capable of displaying drawing image data of a construction drawing on a screen, so that a user can easily understand the contents of the construction drawing in relation to other construction drawings.

[Solution] The image display system of the present invention includes a data acquisition unit for acquiring document image data, an identification unit for identifying installation regions of construction elements in document image data, an attribute assignment unit for reading text information of the document image data to generate attribute data and assigning the attribute data to the construction elements, a document integration unit for integrating the document image data by matching and associating the construction elements between at least two document image data on the basis of at least one of the installation region of the construction elements and the attribute data assigned to the construction elements, and an image display unit for displaying on the screen the document image data integrated by the document integration unit by associating the construction elements of the document image data with the construction elements of other document image data.

### CROSS-REFERENCE TO RELATED PATENT APPLICATION

This application claims the benefit of and priority to Japanese Patent Application No. 2025-019376, filed on Feb. 7, 2025, the entire disclosure of which is hereby incorporated by reference herein.

### TECHNICAL FIELD

The present invention relates to an image display system and an image display method for displaying, on a screen, document image data of a design document including at least one construction drawing used in construction, as well as an automatic calculation system and an automatic calculation method for automatically calculating the cost of construction utilizing information (data) used in the image display system and the image display method.

### BACKGROUND

In the construction work and construction project of a building, an estimation service is performed in which the materials, process, construction period, etc. required for the work are calculated on the basis of construction drawings (design drawings), etc. so as to calculate the cost of construction work. In the estimation of construction work, typically, a takeoff operation is performed in which a construction estimator with specialized knowledge measures the types and quantities of members such as pipes, ducts and other piping equipment used in construction work, and then the cost of the work is calculated on the basis of the information etc. obtained from the takeoff operation.

However, the aforementioned takeoff operation requires a great deal of time and labor, which places a heavy burden on the estimation service. In order to solve such problems, for example, Japanese U.S. Pat. No. 7,332,068 (Patent Literature 1) discloses an automatic calculation system for automatically calculating, from construction drawings, the length dimensions of piping equipment including pipes and ducts.

By using the automatic calculation system of Patent Literature 1, the actual length dimensions of piping equipment can be automatically calculated from the drawing image data of construction drawings, and the results can be displayed on a screen. Through this system, at least a part of the takeoff operation for piping equipment can be automated, and the operation can be simplified, so the time and labor required for takeoff operation can be reduced, the estimation service can be efficient and rational, and the time for operation can be shortened.

### SUMMARY

In a construction project, from the early-stage basic planning to the completion of a building, various construction drawings, specifications, etc. (hereinafter, a document including construction drawings and specifications may also be referred to as design document) are created for different purposes. A large variety of construction drawings are essential for the smooth progress in each process of construction work and for precise construction. Additionally, as a process progresses, the content of construction drawings may need to be changed or updated, so the number of construction drawings tends to increase.

However, there is a problem that the maintenance of the consistency between construction drawings becomes difficult due to the increase in the variety and number of construction drawings. For example, if, in terms of the dimensions of construction materials such as walls and doors, there is inconsistency between different construction drawings showing the same building, it is likely to cause confusion at a construction site. Furthermore, if the inconsistency between construction drawings is found during construction, design changes or additional work may be required, and construction schedules may be delayed, which are the main causes of the increase in cost. In addition, if there is inconsistency between construction drawings, it is difficult to perform a precise takeoff operation during estimation service, and the precision of construction cost estimation may also be reduced.

The present invention has been made in view of the aforementioned conventional problems, with an objective of providing an image display system and an image display method capable of displaying drawing image data of at least one construction drawing on a screen, so that a user can easily understand, between multiple design documents including at least one construction drawing, the contents of a construction drawing in relation to other design documents.

In order to achieve the aforementioned objective, the image display system provided by the present invention is an image display system for displaying, on a screen, document image data of design documents including at least one construction drawing used in construction, where the image display system includes a data acquisition unit for acquiring the document image data of each of the multiple design documents including the at least one construction drawing; an identification unit for identifying the installation region of at least one construction element described in the acquired document image data of the construction drawing; an attribute assignment unit for reading text information described in each of the document image data to generate attribute data and assigning the generated attribute data to the construction elements whose installation regions were identified by the identification unit; a document integration unit for integrating the document image data of the multiple design documents including the at least one construction drawing by matching and associating, between at least two document image data, on the basis of at least one of the installation region of each of the construction elements and the attribute data assigned to each of the construction elements, the construction elements whose installation regions were identified by the identification unit; and an image display unit for displaying on the screen the document image data of the at least one construction drawing included in the document image data integrated by the document integration unit by associating the construction elements described in the document image data with the construction elements described in other document image data.

In the image display system of the present invention, it is preferred that the attribute data of the construction elements includes at least one of the type, shape, size, material, position and orientation of the construction elements.

Additionally, it is preferred that the identification unit includes an array data generation unit for generating array data including image information from the document image data of the construction drawing acquired by the data acquisition unit; and an element identification unit for identifying the type and the installation region of the construction element using a machine learning model generated by machine learning with the array data of the document image data of the construction drawing as input and binary data indicating the installation regions of the construction elements in the array data as output.

Furthermore, it is preferred that the attribute assignment unit includes a reading unit for reading text information from the document image data by means of OCR processing; and a natural language processing unit for performing natural language processing for the read text information to generate the attribute data.

In the present invention, it is preferred that the image display unit displays the attribute data assigned to the construction elements in association with the construction elements. Additionally, it is preferred that a database for storing at least one of information about a building to be constructed and information about each of the construction elements used in the building is included, and the attribute assignment unit refers to the information stored in the database when assigning the attribute data to the construction elements.

It is preferred that if modifications of the construction elements are made in the design documents, the data acquisition unit acquires the document image data of the design documents before the modifications of the construction elements and the document image data of the design documents after the modifications of the construction elements, the document integration unit integrates the document image data of the design documents before the modifications and the document image data of the design documents after the modifications of the construction elements, and the image display unit displays the document image data of the design documents before the modifications and the document image data of the design documents after the modifications of the construction elements.

Additionally, it is preferred that the document integration unit includes a matching unit for comparing the attribute data of corresponding construction elements between the at least two document image data and matching the construction elements; an image data integration unit for integrating the at least two document image data with the matching of the construction elements confirmed; a comparison and confirmation unit for comparing the attribute data of the corresponding construction elements between the integrated document image data and confirming the consistency of the attribute data; and an inconsistency notification unit for identifying the construction elements with inconsistent attribute data confirmed in the comparison and confirmation unit and notifying a user.

In this case, it is preferred that the inconsistency notification unit performs processing for displaying, in the document image data of the design documents displayed by the image display unit, the content of inconsistency in the attribute data, and/or processing for creating and sending an inquiry e-mail with the content of the inconsistency in the attribute data.

Furthermore, according to the present invention, an automatic calculation system is provided in which at least a part of the cost of the construction is automatically calculated, utilizing the installation regions of the construction elements identified by the aforementioned image display system and the attribute data assigned to the construction elements.

Next, the image display method provided by the present invention is an image display method for displaying, on a screen, document image data of design documents including at least one construction drawing used in construction, using the image display system, where the image display method includes a data acquisition step in which the data acquisition unit of the image display system acquires the document image data of each of the plurality of design documents comprising the at least one construction drawing; an identification step in which the identification unit of the image display system identifies the installation region of at least one construction element described in the acquired document image data of the construction drawing; an attribute assignment step in which the attribute assignment unit of the image display system reads text information described in each of the document image data to generate attribute data and assigns the generated attribute data to the construction elements whose installation regions were identified in the identification step; a document integration step in which the document integration unit of the image display system integrates the document image data of the plurality of design documents comprising the at least one construction drawing by matching and associating, between at least two document image data, on the basis of at least one of the installation region of each of the construction elements and the attribute data assigned to each of the construction elements, the construction elements whose installation regions were identified in the identification step; and an image display step in which the image display unit of the image display system displays on the screen the document image data of the at least one construction drawing comprised in the document image data integrated in the document integration step by associating the construction elements described in the document image data with the construction elements described in other document image data.

In the image display method of the present invention, it is preferred that the attribute assignment step includes the attribute assignment unit's reading text information from the document image data by means of OCR processing and performing natural language processing for the read text information to generate the attribute data. Additionally, it is preferred that the image display step includes the image display unit's displaying the attribute data assigned to the construction elements in association with the construction elements.

In the present invention, it is preferred that if modifications of the construction elements are made in the design documents, the data acquisition step includes the data acquisition unit's acquiring the document image data of the design documents before the modifications of the construction elements and the document image data of the design documents after the modifications of the construction elements, the document integration step includes the document integration unit's integrating the document image data of the design documents before the modifications and the document image data of the design documents after the modifications of the construction elements, and the image display step includes the image display unit's displaying the document image data of the design documents before the modifications and the document image data of the design documents after the modifications of the construction elements.

Additionally, it is preferred that the document integration step includes the document integration unit's comparing the attribute data of the corresponding construction elements between the at least two document image data to match the construction elements, integrating the at least two document image data with the matching of the construction elements confirmed, comparing the attribute data of the corresponding construction elements between the integrated document image data to confirm the consistency of the attribute data, and identifying the construction elements with the inconsistent attribute data confirmed through comparison of the attribute data and notifying a user.

In this case, it is preferred that the document integration step includes, upon identification of the construction elements with inconsistency in the attribute data, performing processing for displaying, in the document image data of the design documents displayed by the image display unit, the content of inconsistency in the attribute data, and/or performing processing for creating and sending an inquiry e-mail with the content of the inconsistency in the attribute data.

Furthermore, according to the present invention, an automatic calculation method is provided in which at least a part of the cost of the construction is automatically calculated, utilizing the installation regions of the construction elements identified by the aforementioned image display method and the attribute data assigned to the construction elements.

According to the image display system and the image display method of the present invention, the drawing image data of construction drawings can be displayed on a screen, so that a user can easily understand, between a plurality of construction drawings, the items of each construction drawing in relation to other design documents.

### BRIEF DESCRIPTION OF THE DRAWINGS

FIG. 1 is a block diagram schematically showing the configuration of an image display system in an example of the present invention.

FIG. 2 is drawing image data of a first floor plan view used in the construction of a logistics center.

FIG. 3 is drawing image data of a second floor plan view used in the construction of a logistics center.

FIG. 4 is drawing image data of a sectional view taken along the line Y1 of FIG. 2, which is used in the construction of a logistics center.

FIG. 5 is the drawing image data of a sectional view taken along the line Y2 of FIG. 2, which is used in the construction of a logistics center.

FIG. 6 is the drawing image data of a sectional view taken along the line X1 of FIG. 2, which is used in the construction of a logistics center.

FIG. 7 is drawing image data of a steel column detail view used in the construction of a logistics center.

FIG. 8 is drawing image data of a beam detail view used in the construction of a logistics center.

FIG. 9 is drawing image data of a steel column section list used in the construction of a logistics center.

FIG. 10 is a flow chart of an image display method in an example.

FIG. 11 is a diagram showing binary data obtained by binarizing the drawing image data of the first floor plan view of FIG. 2.

FIG. 12 is a diagram showing data obtained by performing morphological processing for the binary data of FIG. 11.

FIG. 13 is a diagram showing binary data obtained by binarizing the drawing image data of the sectional view of FIG. 4.

FIG. 14 is a diagram showing data obtained by performing morphological processing for the binary data of FIG. 13.

FIG. 15 is an explanatory diagram showing an enlarged portion of the drawing image data of the steel column detail view of FIG. 7, and illustrating text information read from the drawing image data.

FIG. 16 is an explanatory diagram showing an enlarged portion of the drawing image data of the beam detail view of FIG. 8, and illustrating a construction element (beam of steel column) identified from the drawing image data.

FIG. 17 is an explanatory diagram illustrating the matching of construction elements (walls) between the drawing image data of the second floor plan view of FIG. 3 and the drawing image data of the sectional view of FIG. 5.

FIG. 18 is an explanatory diagram illustrating the matching of construction elements (walls) between the drawing image data of the second floor plan view of FIG. 3 and the drawing image data of the sectional view of FIG. 5.

FIG. 19 is an explanatory diagram illustrating the matching of construction elements (walls) for the updated drawing image data of the second floor plan view.

FIG. 20 is drawing image data of fire-extinguishing equipment diagram.

FIG. 21 is an explanatory diagram illustrating construction elements identified in drawing image data of a plan view (layout view) used in the construction of an apartment building.

FIG. 22 is an explanatory diagram illustrating construction elements identified in drawing image data of a piping diagram used in the construction of an apartment building, and attribute data assigned to the construction elements.

FIG. 23 is drawing image data of a plan view (floor plan) used in the construction of a detached house.

FIG. 24 is an explanatory diagram illustrating construction elements identified in drawing image data of the plan view of FIG. 23.

### DETAILED DESCRIPTION

Preferred embodiments of the present invention will be described below with reference to examples and drawings.

The image display system in the present example is a system that integrates, for document image data of multiple design documents used in construction, two or more document image data by associating construction elements described in one document image data (drawing image data) of a construction drawing with construction elements and information thereof described in other document image data, and displays drawing image data of at least one construction drawing on a screen, with the construction elements of the drawing image data associated with the same construction elements shown in other document image data. In this example, a case will be described in which the document image data (drawing image data) of construction drawings used in the construction of a logistics center are displayed on a screen of a user terminal using the image display system.

In the present invention, a “design document” refers to a document and a drawing with information on the design, construction and maintenance management of a building. The design document includes, for example, a construction drawing used in construction, a specification (a standard specification, a special specification, etc.) describing construction materials and methods, a construction plan summarizing the plan of a construction project, and an as-built drawing.

The “construction drawing” includes various drawings such as a general drawing, a design drawing, a structural drawing, an equipment drawing, a detail drawing, a sectional drawing, and a system drawing used to construct a building. The construction drawing may also be referred to as a design drawing or an architectural drawing. The general drawing is a drawing that shows the overall plan of a construction project. The general drawing includes, for example, a plan view, a sectional view, an elevation view, and a layout view. The design drawing is a drawing with the shape, configuration, layout, etc. of a building. The design drawing includes, for example, a plan view, a sectional view, an elevation view, an exterior layout view, a key plan of doors and windows, a layout view of construction elements, a door and window schedule (a list of doors and windows), and a section list. Note that in the present invention, the door and window schedule and the section list are included in the construction drawing as an important component (document) of the design drawing, but may also be treated as a design document other than the construction drawing.

The structural drawing is a drawing that shows the dimension, position, etc. of an object structurally supporting a building, such as a column, a beam, a wall, a floor, a sash, glass, a door and a window, and an interior building material. The structural drawing includes, for example, a standard drawing, a plan view (top view), a framing elevation, and a structural details drawing. The equipment drawing is a drawing about the type, specifications, wiring and piping routes, and layout of equipment installed at a building. The equipment drawing includes, for example, an air-conditioning and ventilating equipment drawing, an electrical equipment drawing, a gas equipment drawing, and a water supply and drainage sanitation equipment drawing.

Document image data of a design document is data of an image representing the design document, and the document image data includes, for example, an image file such as JPEG, GIF, PNG and BMP, and a document file such as PDF. The document image data of the design document is obtained, for example, by reading a construction drawing printed on paper etc. by means of OCR processing, and saving in a predetermined file format. In the following description, among the document image data of the design document, document image data showing the construction drawing may also be referred to as drawing image data.

Note that the drawing image data of the construction drawing does not include, for example, CAD data that are created by a CAD software and that allows the length and angle of a line to be changed on a computer. However, for example, an image file obtained by printing CAD data or PDF data outputted from the CAD data and reading the printed construction drawing by means of OCR processing is included in the drawing image data (document image data) of the present invention. In the image display system and image display method of the present invention, the construction drawing used in construction is not particularly limited in type, number, size, etc., as long as at least one construction drawing, preferably two or more construction drawings, can be read as drawing image data.

In the present invention, a “construction element” is a comprehensive term that includes, for example, construction materials, ingredients and equipment necessary for the construction of a building, as well as a part of the building; and a “construction element” includes, for example, a wall (an outer wall, a boundary wall, etc.), a steel column, a beam (a steel beam), a window, a door, a gate, a sash, glass, a fitting designed to open and close, an interior building material, electrical equipment (wiring, an outlet, a switch, etc.), water supply and drainage equipment (piping, a connecting member, etc.), air-conditioning equipment (a duct, an air-conditioning unit, etc.), a substrate material, a roof material, an outer wall material, an interior material, a floor material, a wall material, and a room (layout). Additionally, in the following description, the type of a construction element refers to the type of each of a wall, a steel column, a beam, a window, a door, etc.

### Configuration of Image Display System

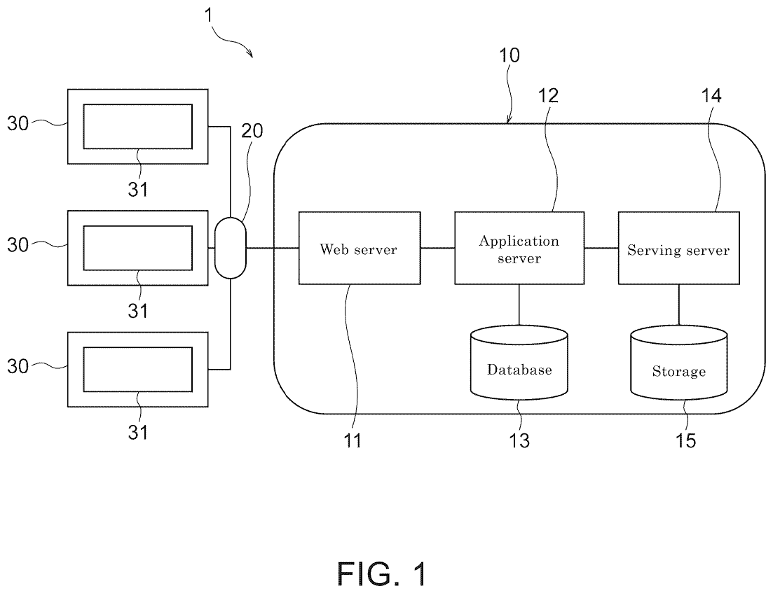

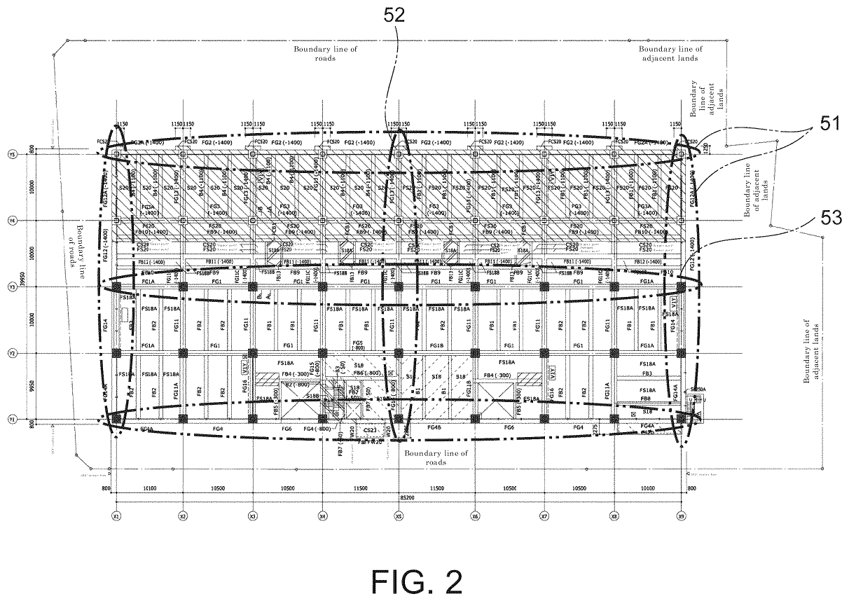

FIG. 1 is a block diagram schematically showing the configuration of an image display system 1 in the present example. In the present example, a case will be described in which a logistics center is constructed as a building, and drawing image data of at least one of multiple construction drawings (see, for example, FIGS. 2-9) used in the construction project are displayed on a screen. Note that in the present invention, the building to be constructed is not limited to a logistics center.

As shown in FIG. 1, an image display system 1 of the present example includes a management server 10 and multiple user terminals (client terminals) 30 communicatably connected to the management server 10 via a network 20. The network 20 is formed by the Internet, an intranet, an LAN, a WAN, etc.

The management server 10 of the present example is formed by one or more virtual servers (cloud servers). Note that the management server 10 may also be formed by one or more physical servers. The management server 10 includes a web server 11 for sending data to and receiving data from the user terminal 30, an application server 12 for receiving requests from the web server 11 and executing various processing, and a database (database server) 13 for managing various data.

Additionally, the management server 10 includes a serving server 14 on which a below-mentioned machine learning model (hereinafter abbreviated as “learning model”) used in the present example is deployed, and a storage 15 (for example, a cloud storage) for storing the learning model and various data related to the learning model.

The web server 11 of the management server 10 receives the content requested by a web browser 31 of the user terminal 30, and performs processing according to the content. The application server 12 executes various processing according to requests from the web server 11, and also accesses the database 13 to perform processing such as reading, writing, processing and searching data.

The database 13 stores programs for executing each processing and each function, as well as various data such as data required for the programs, data on a building and data on construction elements. For example, the database 13 in the present example stores various information on a building to be constructed, and various information on various construction elements used in the building (for example, information described in the catalog of each construction element). Additionally, the database 13 in the present example stores construction-related laws and regulations, including the Construction Standard Law etc. The serving server 14 receives input from the application server 12 and executes the learning model, and outputs the results obtained by the learning model to the application server 12.

The management server 10 has a function of providing a web application to a web browser 31 running on the user terminal 30, and the web application is displayed on the web browser 31 of the user terminal 30. Additionally, data are sent and received between the web server 11 of the management server 10 and the web browser 31 of the user terminal 30 via an API (Application Programming Interface).

Each user terminal 30 is formed as a computer, a tablet terminal, a smartphone, etc. used by each user, and includes a web browser 31 capable of utilizing a web application. If the user terminal 30 is, for example a computer, the user terminal 30 includes a CPU for processing and controlling the operation of the entire terminal (not shown), a communication IF (interface), an input device for receiving an input operation from a user, an output device for displaying information, a memory for temporarily storing programs, data, etc., and a storage unit for saving data, all of which are electrically connected.

In this case, the input device is formed by, for example, a mouse, a keyboard, a touch panel and a touch pad. The output device is formed by, for example, a screen (a display). The memory is formed by a volatile memory such as DRAM. The storage unit is formed by, for example, an HDD, and a flash memory. Note that in the present invention, the user terminal 30 is not particularly limited as long as it at least includes the web browser 31 for displaying the web application.

The web application used on the user terminal 30 includes a data acquisition unit for acquiring document image data of design documents, and an image display unit for displaying, on the screen of the output device, the drawing image data (document image data) of at least one construction drawing in the document image data integrated by the association of construction elements on the application server 12, in association with the construction elements shown in other document image data.

Particularly, in the present example, the data acquisition unit can acquire the drawing image data of at least two construction drawings, and the image display unit can display on the screen the drawing image data of the at least two construction drawings in which the construction elements are associated with each other. Additionally, if the modification of the construction elements is made in the design documents, the data acquisition unit can acquire the document image data of the design documents before the modifications of the construction elements and the document image data of the design documents after the modifications of the construction elements, and the image display unit can display the document image data of the design documents before the modifications and the document image data of the design documents after the modifications of the construction elements.

The application server 12 of the management server 10 includes an identification unit for identifying the installation regions of at least one construction element shown in the drawing image data acquired by the data acquisition unit, and an attribute assignment unit for reading text information described in each document image data of the multiple design documents to generate attribute data and assigning the generated attribute data to the construction elements.

Particularly, in the present example, the identification unit can identify, in each of the drawing image data of at least two construction drawings acquired by the data acquisition unit, the installation region of at least one construction element shown in each drawing image data, and the attribute assignment unit can assign the attribute data to each construction element whose installation region was identified in at least two drawing image data.

Additionally, the application server 12 includes a document integration unit for integrating the document image data of the multiple design documents including at least one construction drawing (preferably at least two construction drawings) by matching and associating, between the document image data of at least two design documents, on the basis of at least one of the installation region of each construction element identified by the identification unit and the attribute data assigned to each construction element by the attribute assignment unit, the construction elements whose installation regions were identified; and a calculation unit for automatically calculating at least a part of the cost of construction by utilizing the construction elements and the attribute data assigned to the construction elements. In this case, the calculation unit is configured to be able to acquire, for example the scale information of each construction drawing and calculate the size (length) of each construction element.

The identification unit of the application server 12 includes an array data generation unit for generating array data including image information from the drawing image data of the construction drawing acquired by the data acquisition unit; and an element identification unit for identifying the type of construction elements and the installation regions ofthe construction elements using a below-mentioned machine learning model. The attribute assignment unit of the application server 12 includes a reading unit for reading text information from the document image data of each design document by means of OCR processing; and a natural language processing unit for performing natural language processing for the read text information to generate the attribute data. Thereby, the attribute data can be stably generated from the text information described in each document image data.

The document integration unit of the application server 12 includes a matching unit for comparing the attribute data of corresponding construction elements and matching the construction elements between the document image data of at least two design documents; an image data integration unit for integrating at least two document image data with the matching of the construction elements confirmed; a comparison and confirmation unit for comparing the attribute data of the corresponding construction elements between the integrated drawing image data and confirming the consistency of the attribute data; and an inconsistency notification unit for identifying the construction elements with the inconsistent attribute data confirmed in the comparison and confirmation unit and notifying a user.

In this case, the matching unit of the document integration unit determines whether the construction elements are the same or not by comparing the attribute data of corresponding construction elements between at least two document image data (particularly at least two drawing image data), and performs the matching of the same construction elements. If the matched construction elements between at least two document image data are confirmed to account for a predetermined proportion or more in relation to all of the same construction elements in the document image data, the image data integration unit of the document integration unit integrates the at least two document image data with the matched construction elements.

When the construction elements with inconsistency in at least a part of the attribute data were identified between the two or more integrated document image data, the inconsistency notification unit of the document integration unit performs an attribute inconsistency warning for warning that the contents of the corresponding attribute data of the construction elements are different between the two or more document image data. For example, the warning by the inconsistency notification unit can include displaying, in the document image data of the design documents (particularly the drawing image data of the construction drawing) displayed by the image display unit, the content of inconsistency in the attribute data, and/or creating and sending an inquiry email with the content of the inconsistency in the attribute data. Furthermore, the document integration unit in the present example includes a law-and-regulation warning unit for comparing the construction elements whose installation regions were identified in drawing image data and the attribute data assigned to construction elements with construction-related laws and regulations, and issuing a warning of non-compliance with laws and regulations if any part is confirmed to be non-compliant with the construction-related laws and regulations.

In the present example, the data acquisition unit and image display unit of the web application, as well as the identification unit, attribute assignment unit, document integration unit and calculation unit of the application server 12 are respectively formed by a computer program. In the image display system 1 of the present example, the functions of the image display system 1 are realized by the cooperation of software and hardware resources and the execution of the aforementioned computer programs.

Note that in the present invention, at least a part of the data acquisition unit and the image display unit of the web application may also be included in the application server 12. At least a part of the identification unit, the attribute assignment unit, the document integration unit and the calculation unit of the application server 12 may also be included in the web application.

### Description of Learning Model

Next, a learning model used in the image display system 1 of the present example will be described. A learning model is a model utilizing machine learning which is sometimes called artificial intelligence. The machine learning itself can utilize various known methods, and for example, a neural network may be used. Note that the learning model generated by machine learning in the present example is sometimes called a fine-tuning model.

The learning model (fine-tuning model) in the present example is generated by performing substantially the same processing as the learning model described in the aforementioned Patent Literature 1, and specifically, is generated by machine learning with the array data of drawing image data as input and the binary data indicating the installation regions of specific construction elements in the array data as output.

The generated learning model includes an input layer to which the array data generated from the drawing image data of one construction drawing is input, an output layer that outputs the binary data indicating the installation regions of the construction elements and the type of the construction elements indicated by the installation regions, and an intermediate layer in which parameters were machine-learned using multiple training data recorded by associating the array data of drawing image data with the type of specific construction elements and binary data.

Here, the array data inputted to the input layer of the learning model are data converted and generated from the drawing image data of the construction drawing by the array data generation unit of the application server 12, and the array data include image information. For example, in the case of the present example, the array data include information on the image width, image height, and grayscale pixel value of the drawing image data. Note that in the present invention, as a substitute for grayscale pixel value, RGB pixel value may be used for the array data.

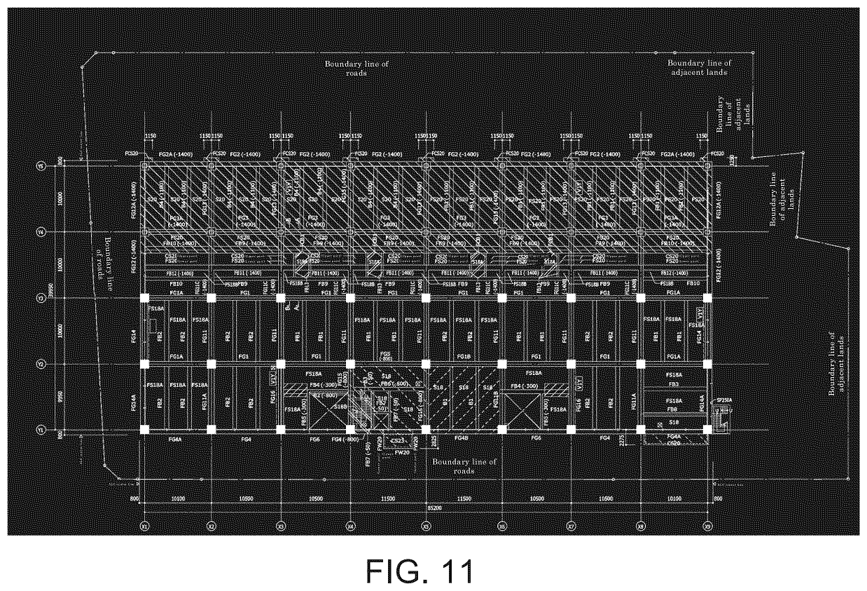

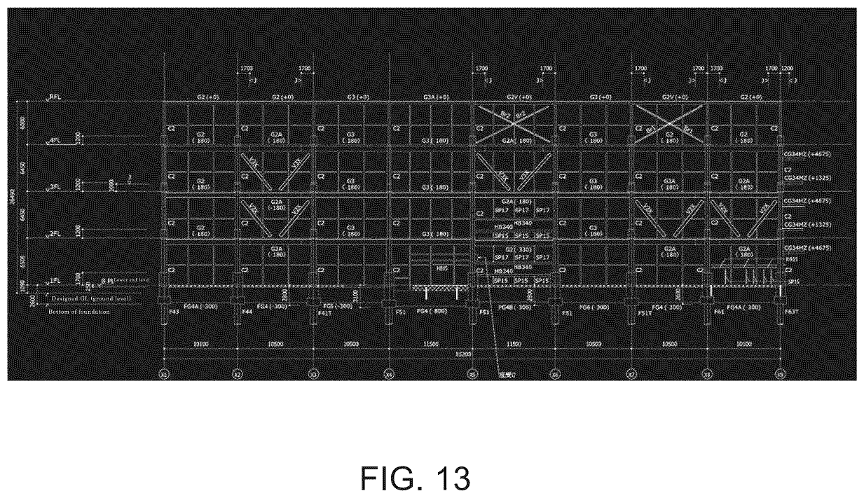

As will be described later, the binary data are binarized data formed to extract from the array data the construction elements included in the drawing image data, and are data for separating and extracting the specific construction elements from the background part by masking the background part, other than the specific construction elements such as walls and steel columns, of the array data (see, for example, FIGS. 11 and 13). The binary data are formed by two values, “0” and “1”.

As described in Patent Literature 1, the learning model in the present example is generated by pre-training for generating a pre-trained model and transfer learning for performing the transfer learning of the pre-trained model. Note that in the automatic calculation system described in Patent Literature 1, a learning model is used which is generated by inputting the array data of drawing image data, so that the binary data (equipment binary mask) indicating the installation regions of piping equipment such as pipes and ducts are outputted.

In contrast, in the image display system 1 of the present example, at least one learning model, preferably multiple learning models, are used which were machine-learned in advance by inputting the array data of drawing image data, so that the binary data indicating the installation regions of specific construction elements such as walls and steel columns as well as the type of the construction elements (walls, steel columns, etc.) are outputted.

More specifically, the following learning model is deployed in the image display system 1 of the present example. For example, a learning model is deployed which is generated by the input of the array data of drawing image data so that the binary data indicating the installation region of a wall (including an outer wall and a boundary wall) and the type (i.e., wall) of the construction element indicated by the binary data are outputted (hereinafter, such learning model about wall is abbreviated as “wall learning model”). Additionally, a learning model is also deployed which is generated by the input of array data so that the binary data indicating the installation region of steel column and the type (steel column) indicated by the binary data are outputted (hereinafter, such learning model about steel column is abbreviated as “steel column learning model”).

Furthermore, in the image display system 1 of the present example, one or more learning models generated to be capable of outputting specific types of construction elements and their installation regions described in drawing image data (for example, a window learning model, a door learning model and a electrical equipment learning model), and/or one or more learning models generated to be capable of outputting construction elements (for example, ducts) included in a construction element group including several construction elements (for example, pipes and ducts), and their installation regions (duct installation region) (hereinafter, such learning model is sometimes abbreviated as “group learning model”) are further deployed.

By deploying the aforementioned multiple learning models in the image display system 1 of the present example, in each learning model, from one drawing image data, the respectively machine-learned construction element type and binary data indicating construction element installation region can be outputted to the application server 12. Note that it is possible as long as at least one learning model that outputs at least one type of construction element and binary data indicating the installation region of the construction element is deployed in the image display system 1 of the present invention.

The multiple learning models used in the present example are each generated as a learning model that outputs a specific type of construction element and its installation region, or as a learning model that outputs a construction element included in a specific construction element group and its installation region, by performing a pre-training and a transfer learning that are substantially the same as the pre-training and the transfer learning described in Patent Literature 1. Here, the pre-training and the transfer learning performed in the present example will be briefly described.

In the present example, in the pre-training performed to generate each learning model, the following steps are performed: (1) a first training step of acquiring first drawing image data of multiple first construction drawings without the description of specific construction elements such as walls and steel columns; (2) a second training step of automatically adding virtual specific construction elements (such as walls and steel columns) to each of the acquired first drawing image data so as to generate temporary drawing image data; (3) a third training step of generating virtual array data including image information (i.e., image width, image height and grayscale pixel value information) from the temporary drawing image data using a dedicated software program; (4) a fourth training step of dividing the generated virtual array data into multiple divided patch data, and performing masking for some of the obtained divided patch data to generate masked array data; and (5) a fifth training step of generating a pre-trained model by means of error back-propagation method, using the generated virtual array data and the masked array data.

The first training step to the fifth training step in the pre-training are respectively performed in substantially the same manner as the first training step to the fifth training step described in the pre-training of Patent Literature 1. For example, in the fifth training step, by utilizing error back-propagation method and using multiple groups of paired data group with the divided patch data of the masked array data generated by masking the virtual array data as input and the divided patch data of the virtual array data (unmasked array data) as output, the relationship between the two data is learned so that the virtual array data can be restored from the masked array data, and the internal information of the pre-trained model is updated. Then, the fifth training step is completed when the pre-trained model is able to calculate the expected output for any input with a certain probability. Thereby, a pre-trained model for specific construction elements is generated.

Next, transfer learning is performed for each pre-trained model generated for specific construction elements in the pre-training. Here, transfer learning refers to machine-learning for the effective use of the pre-trained model generated by the pre-training in the task of recognizing specific construction elements; in other words, machine-learning which divided patch data of the array data works in the region of specific construction elements.

In this transfer learning, the following steps are performed: (1) a first learning step of acquiring, in a computer, a large amount of second drawing image data of a second construction drawing with the description of the specific construction elements of interest; (2) a second learning step of converting from the acquired second drawing image data into second array data including image information (i.e., information on image width W, image height H, and grayscale pixel value) to generate the second array data, using a dedicated software program; (3) a third learning step of acquiring binary data (equipment binary mask) generated by performing annotation for the generated second array data; and (4) a fourth learning step of subjecting the pre-trained model to transfer learning so as to generate a learning model, using the second array data generated in the second learning step and the binary data acquired in the third learning step.

The first learning step to the fourth learning step in the transfer learning are respectively performed in substantially the same manner as the first learning step to the fourth learning step described in the transfer learning of Patent Literature 1. For example, in the fourth learning step, the pre-trained model is subjected to transfer learning, utilizing error back-propagation method and using multiple training data that enable calculation to be performed with the second array data of the second drawing image data as input and the binary data as output. Through this transfer learning, a learning model is generated to be capable of calculating which part of construction drawing is the region of the specific construction element of interest. The learning model generated by performing the fourth learning step is the fine-tuning model.

Additionally, in the transfer learning of the present example, after the binary data are acquired by performing the aforementioned annotation, a hint step may be performed in which by means of a software program dedicated to hint mask, a part of data are randomly selected from the generated binary data and designated (generated) as hint binary data. By using the hint binary data designated in such hint step and the second array data of the second drawing image data as input, a learning model with a higher correctness can be generated.

According to the fine-tuning model of the present example generated by performing the aforementioned pre-training and transfer learning, the array data of drawing image data of construction drawing are inputted to the input layer, and thereby in the intermediate layer, the binary data indicating the installation region ofat least one specific construction element can be calculated, and the calculated binary data and the type of construction element indicated by the binary data can be precisely and stably outputted from the output layer.

### Image Display Method Using Image Display System

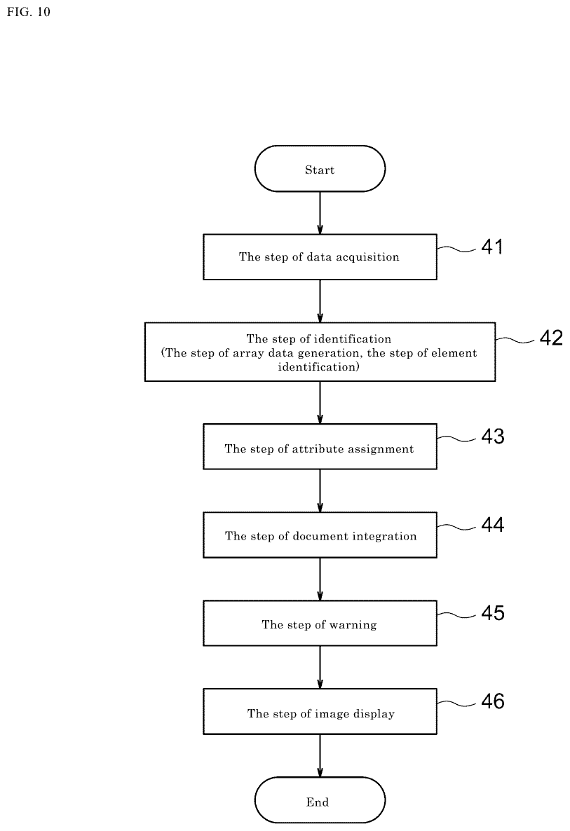

Next, a method for displaying on the screen of the user terminal 30 the drawing image data of at least one of the multiple construction drawings used in the construction of a logistics center will be described with reference to the drawings. Here, FIG. 10 is a flow chart of the image display method of the present example. In the image display system 1 of the present example, at least one learning model (preferably, multiple learning models) described above is deployed on the management server 10 shown in FIG. 1.

In the image display system 1 of the present example, as shown in FIG. 10, first, the data acquisition unit of the image display system 1 performs a data acquisition step 41 in which it acquires the document image data of each of a plurality of design documents (preferably, a plurality of design documents including at least one construction drawing). In the data acquisition step 41 of the present example, the drawing image data (document image data) of each construction drawing shown in FIGS. 2 to 9 is acquired by the data acquisition unit of the user terminal 30.

Specifically, in data acquisition step 41, as shown in FIG. 2 (excluding virtual lines), an image file (e.g., a JPEG file) or a document file (e.g., a PDF file) of a first floor plan view of a logistics center is loaded as drawing image data into the web application of the web browser 31 included in a user terminal 30 shown in FIG. 1. Thereby, the web application of the user terminal 30 acquires the drawing image data of the first floor plan view shown in FIG. 2, and displays the drawing image data of the first floor plan view on the screen of the user terminal 30 using the GUI of the web application.

Additionally, as for the drawing image data of the first floor plan view shown in FIG. 2, in the application server 12, after the text information shown in the drawing image data is read by means of a below-mentioned OCR processing, a below-mentioned natural language processing is performed, and thereby in the drawing image data of the first floor plan view, from the text information (not shown) of the “first floor plan view” described as drawing name, the drawing image data shown in FIG. 2 is recognized as the drawing image data of the first floor plan view.

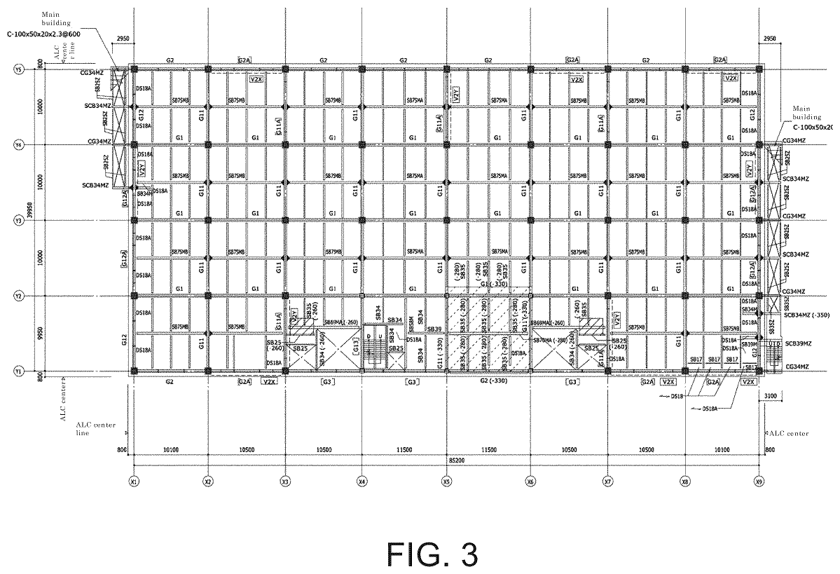

In the data acquisition step 41, in addition to the drawing image data of the first floor plan view of FIG. 2, the web application of the user terminal 30 acquires the drawing image data of each of the second floor plan view, the Y1-line sectional view, the Y2-line sectional view, the X1-line sectional view, the steel column detail view, the beam detail view and the steel column section list respectively shown in FIGS. 3-9 (excluding virtual lines and dashed lines), in the same manner as in the case of the drawing image data of the first floor plan view. Additionally, each drawing image data are subjected to OCR processing and natural language processing in the application server 12, so as to recognize the type of the drawing image data of construction screen.

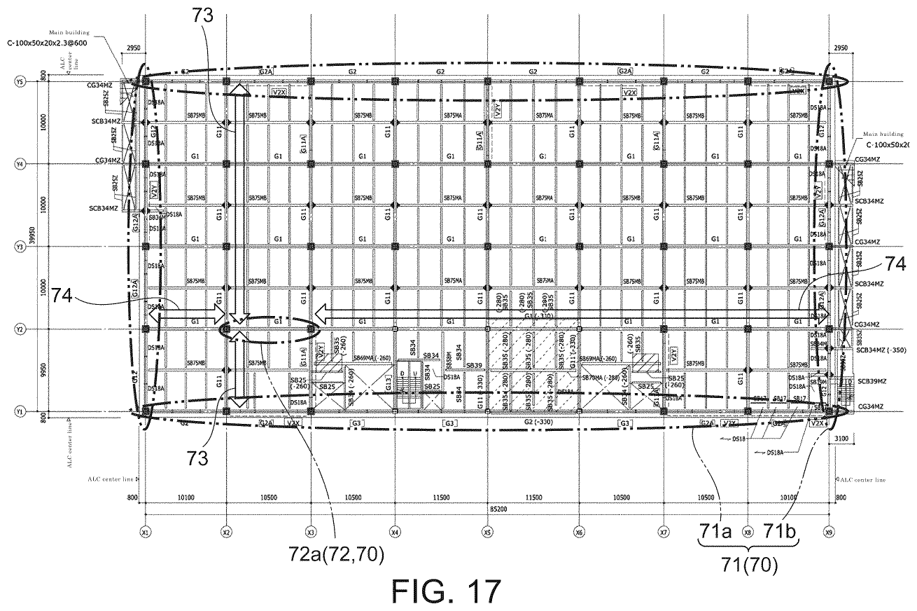

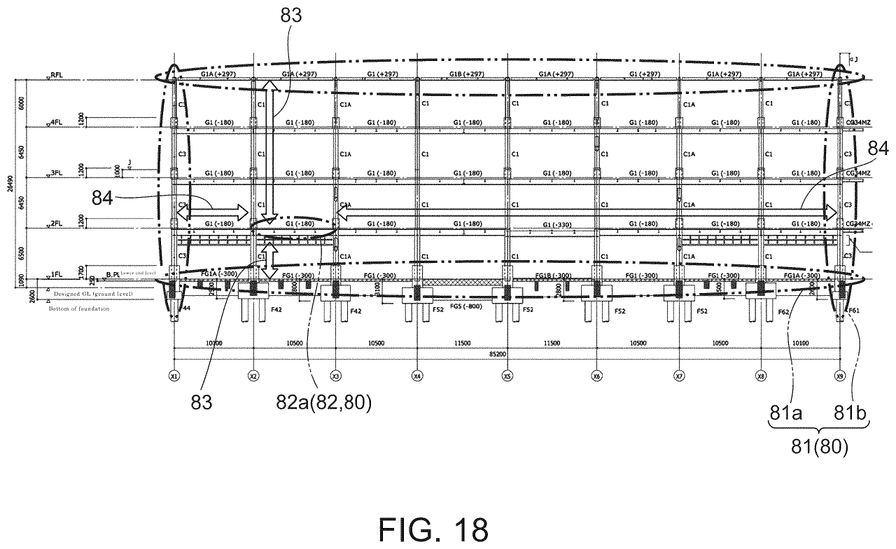

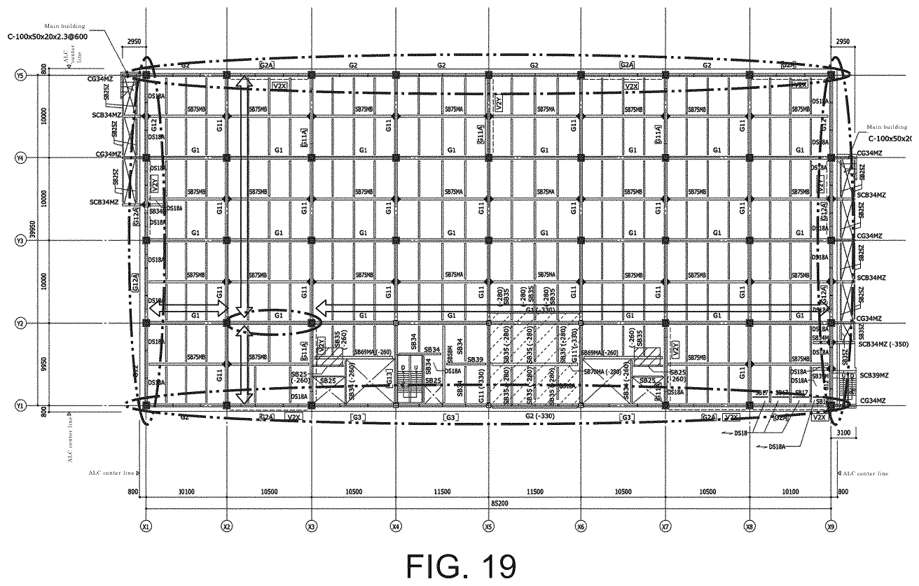

Note that the present example is merely an example of the image display system 1 and the image display method of the present invention, and the drawing image data acquired in the data acquisition step 41 of the present invention is not limited to the above. For example, in the data acquisition step 41 of the present example, when the construction drawing of a logistics center is displayed, as the drawing image data, the drawing image data of at least one of the plan views of the third floor and higher of the logistics center, the sectional views of X2-line to X9-line and Y3-line to Y5-line, other sectional views, the framing elevation, the detail view such as a key plan, and the partially detailed view may also be acquired. Additionally, the drawing image data (see FIG. 17) of the construction drawing before the change, addition, deletion, etc. of construction elements (the construction drawing before version upgrade), and the drawing image data (see FIG. 19) of the construction drawing after the change, addition, deletion, etc. of construction elements (the construction drawing after the version upgrade) may also be acquired.

The drawing image data (see FIGS. 2-9) of each construction screen obtained by the web application are sent to the management server 10 via an API, and thereby inputted to the application server 12 via the web server 11 of the management server 10 (see FIG. 1). At this time, in the web application that acquired the drawing image data, the drawing name and scale information described in the drawing image data can also be read and acquired using the OCR function included in the web application. Note that the drawing name and scale information may also be acquired by, for example user's manual input into the web application with an input device of the user terminal 30 or the selection on the web application.

In the web application, it is also possible to identify the type of a building and send the identified type to the application server 12 by receiving the input of the type of the building for which multiple construction drawings have been created. For example, in the case of the present example, it is also possible to identify the logistics center as the type of building and send the type of building (“logistics center”) to the application server 12 by user's entering “logistics center” in a predetermined entry field displayed in the web application for the entering of the type of building. Note that the type of building may also be identified by reading from the text information shown in any of the drawing image data in the attribute assignment step 43 described below.

Next, the aforementioned identification unit of the application server 12 performs an identification step 42 of identifying the type of construction element and its installation region shown in each of the drawing image data of FIGS. 2-9 sent from the web application. Specifically, in the identification step 42, first, the array data generation unit of the identification unit performs an array data generation step of converting and generating array data including information on image width, image height and grayscale pixel value (e.g., data of “W×H×the number of pixels”) from the drawing image data acquired by the web application (e.g., the image data shown in FIG. 2). In the array data generating step, array data are respectively generated for all the drawing image data (the drawing image data of FIGS. 2-9) acquired in the data acquisition step 41.

Next, in identification step 42, the element identification unit of the application server 12 performs an element identification step of identifying the type of construction element described in each construction drawing and the installation region of the construction element using a machine-learned learning model (fine-tuning model). In the element identification step, first, the array data of each drawing image data (data of “W×H×the number of pixels”) generated by the array data generation unit are respectively inputted to multiple learning models.

Specifically, the application server 12 inputs the array data generated in the array data generation step into at least one input layer of learning model, preferably each of the multiple input layers of the learning model, and thereby calculation is performed in the intermediate layer of the learning model, and further the type of construction element identified in the learning model and the binary data indicating the installation regions of the construction elements can be outputted to the application server 12 from the output layer of the learning model.

For example, after performing the aforementioned array data generation step for the drawing image data of the first floor plan view shown in FIG. 2, the acquired array data are inputted into a wall learning model that performs the identification of walls (outer walls and boundary walls), and thereby as shown in FIG. 11, the binary data is generated in which the wall installation region is identified in white, and the information that the type of the construction element is a wall (an outer wall and a boundary wall) and the binary data indicating wall installation region are outputted to the application server 12.

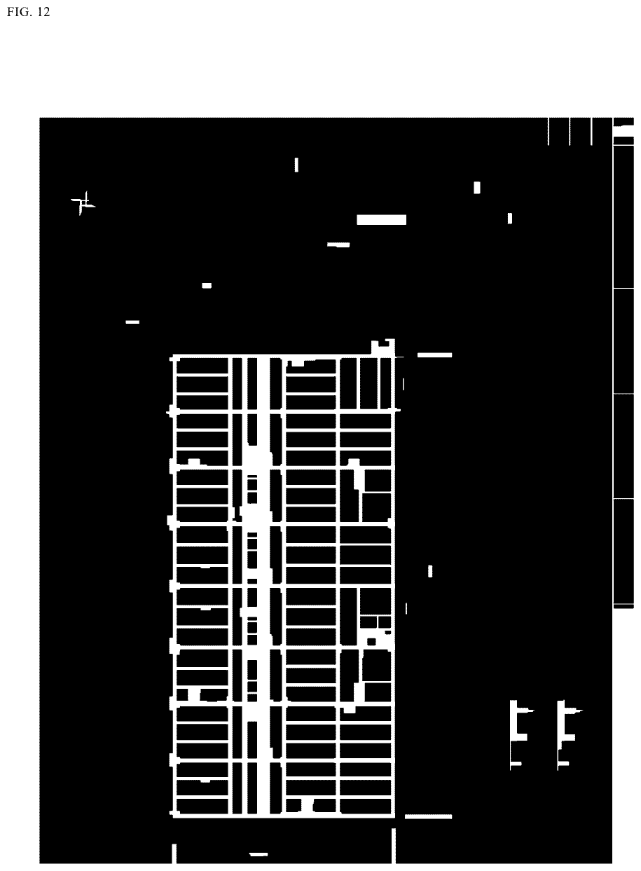

Next, in the element identification step, the element identification unit of the image display system 1 performs morphological processing (also called morphology algorithm processing) forthe binary data outputted from the learning model. The morphological processing is an image processing for emphasizing and extracting the structural features in an image. By performing morphological processing for binary data, the binary data can be changed to make it easier to distinguish the installation regions of construction elements. For example, by performing morphological processing for the binary data shown in FIG. 11 in which the wall installation region is identified in white, the binary data can be acquired in which the wall installation region is easier to distinguish, as shown in FIG. 12.

Thereafter, the element identification unit of the application server 12 uses a post-processing software program to generate wall identification array data in which the wall installation region (for example, the installation region of each of the outer wall 51, the multiple longitudinal boundary walls 52 and the multiple transverse boundary walls 53 illustrated by the two-dot chain line in FIG. 2) is identified on the basis of the array data generated by the identification unit (array data generation unit) and the binary data outputted from the output layer of the learning model.

Additionally, the wall identification array data generated in the element identification step are sent to the web application of the user terminal 30 together with for example the binary data that has been subjected to morphological processing, and thereby the drawing image data of the first floor plan view shown in FIG. 2 can be displayed on the screen of the user terminal 30, and in the drawing image data, when a user performs clicking etc. to select, for example, a wall with identified installation region (e.g., the outer wall 51, the longitudinal boundary wall 52 and the transverse boundary walls 53 illustrated by the two-dot chain line in FIG. 2), the installation region of the selected wall can be displayed in a color different from the surrounding color (red, blue, etc.) or with decoration such as shading. Thereby, the user can easily recognize and understand the installation region ofthe wall in the first floor plan view.

Note that in the present invention, in the element identification step, without performing the aforementioned morphological processing, the element identification array data with identified installation region of construction element may also be directly generated from the binary data outputted from learning model (e.g., FIG. 11) by using a post-processing software program.

Additionally, in the identification step 42 of the present example, the element identification unit of the image display system 1 respectively performs the array data generation step and the element identification step also for the drawing image data other than the first floor plan view shown in FIG. 2 (i.e., the drawing image data of FIGS. 3-9), and thereby for each drawing image data, the binary data are generated in which the installation region ofa specific construction element is identified in white, and the element identification array data are generated in which the installation region of the construction element is identified.

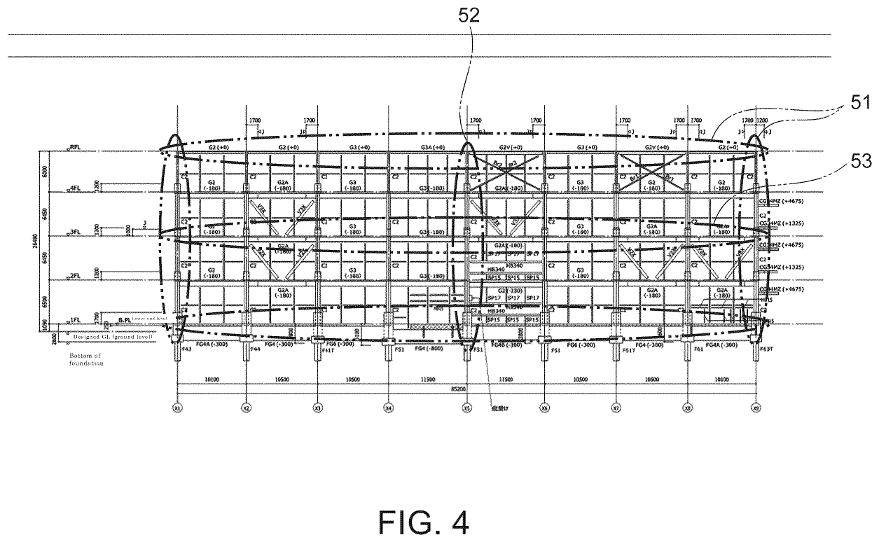

For example, the array data (data of “W×H×the number of pixels”) can be generated by performing an array data generation step for the drawing image data of the Y1-line sectional view shown in FIG. 4, and the binary data shown in FIG. 13 in which the wall installation region is identified in white can be generated and outputted by inputting the array data into a wall learning model.

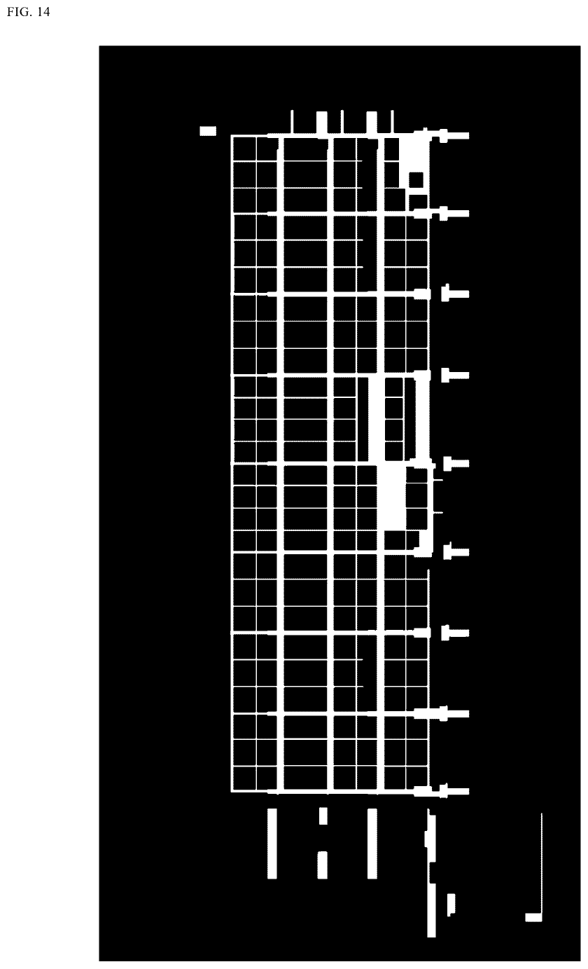

Thereafter, the element identification unit of the application server 12 can acquire the binary data shown in FIG. 14 by performing morphological processing for the binary data of FIG. 13. As a result, in the same manner as the case of the first floor plan view shown in FIG. 2, the wall identification array data can be generated in which the installation region of each of the outer wall 51, multiple longitudinal boundary walls 52 and multiple transverse boundary walls 53 illustrated by the two-dot chain line in FIG. 4 is identified.

Next, in the image display system 1 of the present example, after the aforementioned identification step 42, the attribute assignment unit of the application server 12 performs an attribute assignment step 43 of reading the text information from the drawing image data of each construction drawing to generate attribute data, and assigning the generated attribute data to a construction element (e.g., a wall or a steel column) whose type and installation region was identified in the identification step 42.

Note that the text information includes letters, numbers, symbols, etc. described in the construction drawing. The text information refers to information described to represent at least one of the properties of the construction element, such as the type, shape, size (length), material, position (installation position), orientation, model number, etc. of the construction element. The attribute data of the construction element includes at least one of the type, shape, size (length), material, position (installation position), orientation, model number, etc. of the construction element.

In the attribute assignment step 43, first, the reading unit of the attribute assignment unit reads the text information from the drawing image data by means of OCR processing. The OCR processing is a processing for recognizing letters, numbers, symbols, etc. in the drawing image data and converting them into text data that can be electronically saved, edited and searched, and can also be called text recognition processing.

Next, in the attribute assignment step 43, the natural language processing unit of the attribute assignment unit performs natural language processing for the text information read by the OCR processing so as to generate attribute data. The natural language processing is a technology for enabling a computer to analyze, understand and generate human language through syntactic analysis, semantic analysis, contextual understanding, etc. of text and speech. In the present example, the natural language processing unit of the attribute assignment unit is trained and generated to be able to perform natural language processing more appropriately, especially for the text information used in the construction field.

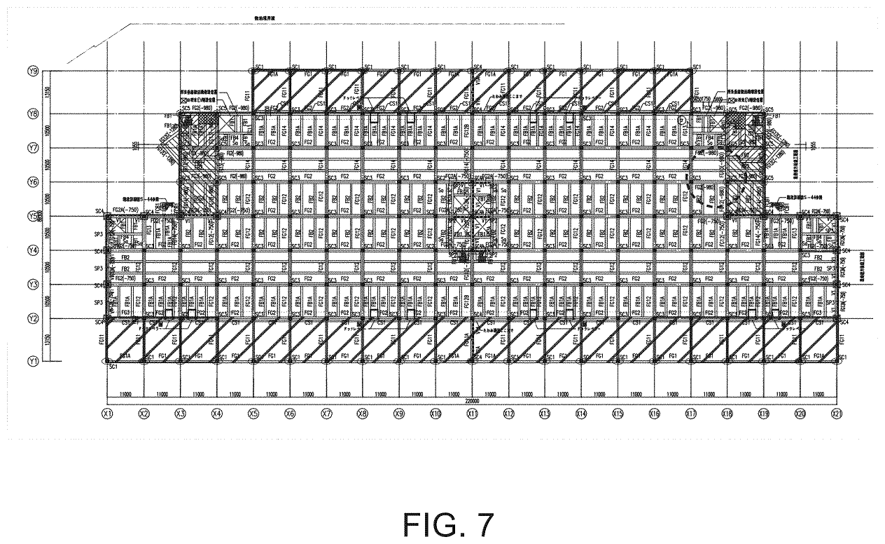

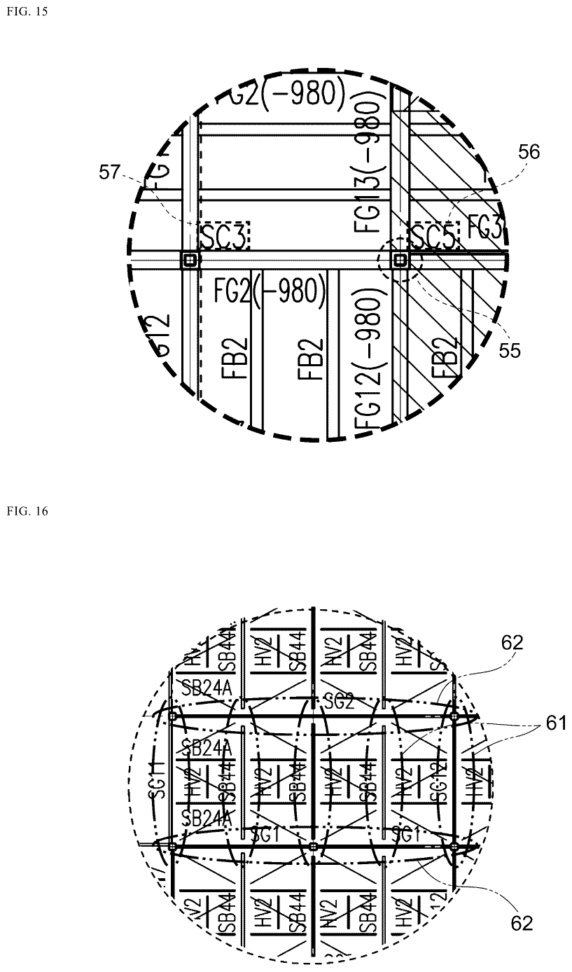

For example, in FIG. 7, the drawing image data of steel column detail view of logistics center are shown, and in FIG. 15, a partially-enlarged view in which the circle shown by dotted line in the steel column detail view of FIG. 7 is enlarged. For the drawing image data of the steel column detail view of FIG. 7, the identification unit of the application server 12 performs the aforementioned identification step 42 using, for example, a steel column learning model, and thereby for the drawing image data of the steel column detail view, the steel column identification array data are generated in which the installation region of the steel column 55 is identified (see FIG. 15).

Next, in the attribute assignment step 43, for the drawing image data of the steel column detail view of FIG. 7, the attribute assignment unit of the application server 12 performs OCR processing, and thereby the text information 56 of “SC5” shown near the installation region of the steel column 55 is first read, as shown in FIG. 15. Additionally, the position information of “SC5” in the drawing image data is also acquired.

Next, the attribute assignment unit of the application server 12 performs natural language processing for the read text information of “SC5”, and thereby it is understood that the text information of “SC5” is one of the attributes related to steel column (for example, a symbol representing the type, size, shape, etc. of steel column), and the attribute data of “SC5” representing the type, etc. of the steel column are generated. Furthermore, one or more attribute data of the generated “SC5” are assigned as one of the attribute data to the steel column 55 whose installation region is identified near the text information of “SC5”.

Note that in the present example, by performing the attribute assignment step 43 for the drawing image data of the steel column detail view of FIG. 7, for example, the part indicating the steel column 55 can be read as a steel column symbol using OCR processing, and by performing natural language processing for the read steel column symbol, the position information of the steel column 55 in the drawing image data can also be assigned to the steel column 55 as one of the attribute data.

Furthermore, in the attribute assignment step 43, by means of the aforementioned OCR processing, in addition to the text information of “SC5”, both the text information 57 of “SC3” shown on the left side of “SC5” and its position information are acquired. Next, by performing natural language processing, one or more attribute data of “SC3” representing the type etc. of steel column are assigned to the steel column near the text information of “SC3”.

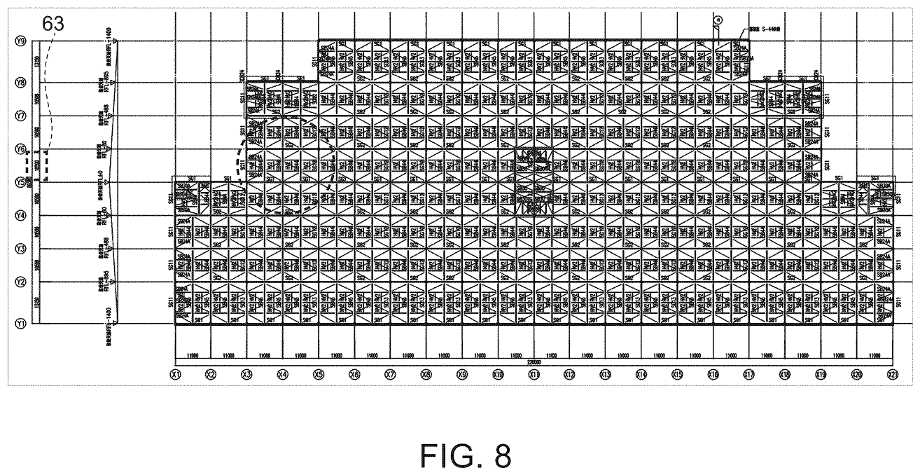

As an example of other construction drawing, for example, FIG. 8 shows a beam detail view of logistics center, and FIG. 16 shows a partially-enlarged view in which the circle shown by the dotted line in the beam detail view of FIG. 8 is enlarged. In this case, in the same manner as the case of the steel column detail view of FIG. 7, by performing the identification step 42 for the drawing image data of the beam detail view of FIG. 8 using a beam learning model that was machine-learned to output the installation region of a beam (steel beam) from the array data of the drawing image data, the beam identification array data are generated in which the installation region of the longitudinal beam 61 and the installation region of the transverse beam 62 are identified for the drawing image data of the beam detail view (see FIG. 16).

Next, by performing attribute assignment step 43 for the drawing image data of the beam detail view of FIG. 8, it is understood that the text information such as “SG11” and “SB44” (the text information described longitudinally) shown near each of the longitudinal beams 61 is one of information on the attributes of the beam (for example, the type, size, shape, etc. of the beam), and the attribute data based on each text information are generated. Furthermore, the generated attribute data are assigned as one of attribute data to the corresponding longitudinal beam 61 near each text information. Additionally, for the transverse beams 62, attribute data based on text information such as “SB24A”, “SG1” and “SG2” shown near the beam 62 are assigned as one of the attribute data to the transverse beam 62 near the text information.

Additionally, in the attribute assignment step 43 for the drawing image data of FIG. 8, the text information 63 of “10,500” shown between the symbol “Y5” and the symbol “Y6” on the left side of the drawing is also read by OCR processing. Furthermore, by performing natural language processing for the read text information 63 of “10,500”, it is understood that “10,500” is a numerical value indicating the length of the longitudinal beam 61, and the attribute data of “beam length is 10,500” is generated on the basis of the text information 63 of “10,500”, and the attribute data are assigned to each of the multiple longitudinal beams 61 installed between Y5-line and Y6-line.

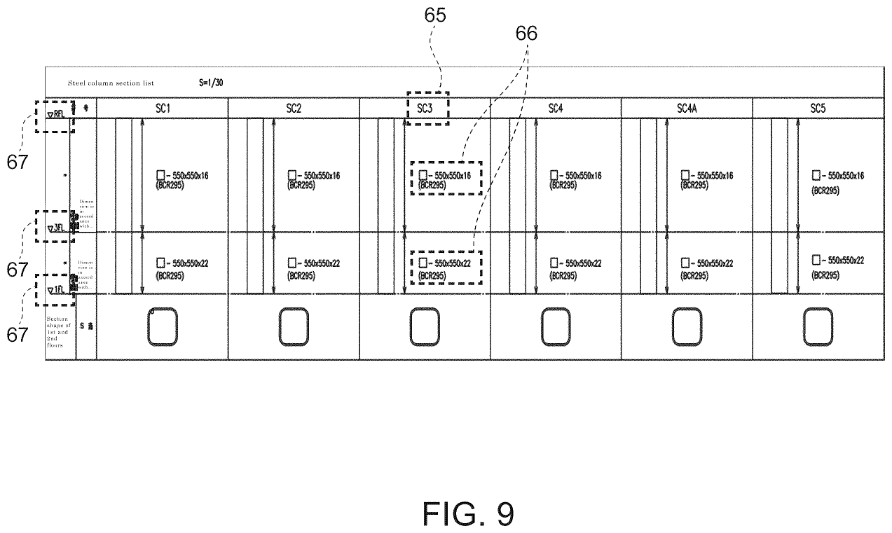

Furthermore, for example, by performing attribute assignment step 43 for the drawing image data of the steel column section list shown in FIG. 9, each of text information shown in the drawing image data of FIG. 9 is read, and by performing natural language processing for the read text information, the attribute data such as the model number (product name) and size of steel column respectively shown below “SC1” to “SC5” can be structured by associating with the attribute data of the “SC1” to “SC5” representing the type etc. of the steel column.

For example, the text information 65 of “SC3” and the text information 66 shown below “SC3” are read, and the natural language processing is performed for the read text information 65, 66, and thereby the attribute data such as the model number (product name) and size of steel column can be structured by associating with the attribute data of “SC3”. Furthermore, by reading the text information 67 of “VRFL”, “V3FL” and “V1FL” shown on the left side of the drawing image data and performing natural language processing, the attribute data on the installation position of steel column can also be structured by associating with the attribute data of “SC1” to “SC5”.

Specifically, the attribute data of the steel column of SC3 installed from the first floor to the third floor are structured by associating with the attribute data that “the size of steel column is 550×550×22”. Additionally, the attribute data of the steel column of SC3 installed from the third floor to the rooftop are structured by associating with the attribute data that “the size of steel column is 550×550×16”.

Additionally, in the attribute assignment step 43 of the present example, when the attribute data are assigned to a construction element, the database 13 is accessed, the information stored in the database 13 is referred to, and if there is information about the construction element, the information about the construction element can be assigned to the construction element as one of the attribute data. For example, if database 13 stores catalog information on construction elements such as steel columns, in addition to the attribute data of the type of steel column such as the aforementioned “SC3”, the information described in the catalog of steel column regarding “SC3” is also assigned as attribute data to the steel column shown in the drawing image data of FIG. 9.

Furthermore, in the natural language processing in the attribute assignment step 43 of the present example, it can also be recognized that the character strings with the same meaning are grouped and represent the same attribute. For example, if one or more drawing image data includes text information such as “toilet”, “WC” and “restroom”, these text information are read using OCR processing, and natural language processing is performed, and thereby all of the text information “toilet”, “WC” and “restroom” are recognized as “toilet”, making it possible to associate the text information with each other or treat them as the attribute data with the same meaning.

After performing the attribute assignment step 43 as described above, the document integration unit of the application server 12 performs a document integration step 44 in which multiple document image data (drawing image data) are integrated on the basis of each construction element (wall, steel column, etc.) and its installation region identified in the identification step 42, and/or at least one attribute data assigned to each construction element in the attribute assignment step 43.

In the document integration step 44, the document image data (drawing image data) are integrated by matching and associating construction elements between at least two different document image data (drawing image data) on the basis of at least one of the installation region of each construction element and the attribute data (at least one attribute data) assigned to each construction element.

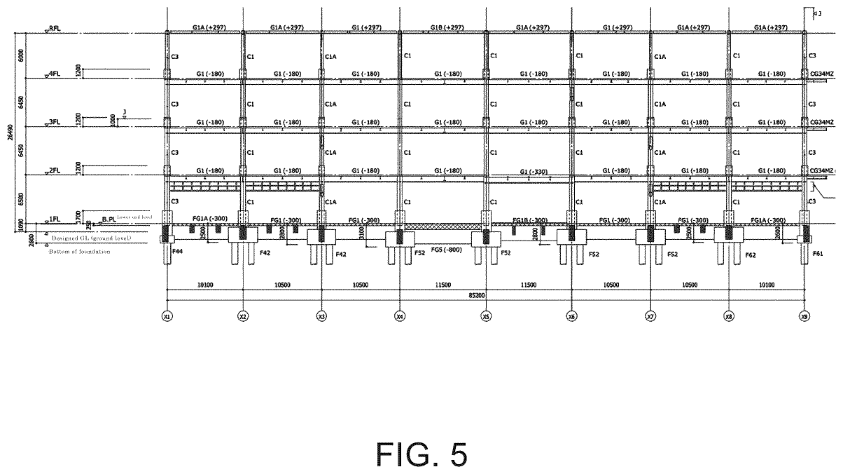

The document integration step 44 will be described in details with reference to FIGS. 17 and 18. FIG. 17 shows drawing image data in which the installation region of wall 70 in the second floor plan view has been identified by performing identification step 42 for the drawing image data of the second floor plan view shown in FIG. 3 using a wall learning model. FIG. 18 shows drawing image data in which the installation region of wall 80 is identified in the Y2-line sectional view by performing identification step 42 for the drawing image data of the Y2-line sectional view shown in FIG. 5 using a wall learning model.

In the document integration step 44 of the present example, the wall 70 identified as a construction element in the identification step 42 in the drawing image data of FIG. 3 and the wall 80 identified as a construction element in the drawing image data of FIG. 5 in the identification step 42 are matched and associated between the two drawing image data on the basis of the installation regions of the walls 70, 80 and the attribute data of the walls 70, 80, thereby the drawing image data of FIG. 3 and the drawing image data of FIG. 5 can be integrated.

For example, by performing identification step 42 for the drawing image data of FIG. 3 using a wall learning model, as shown in FIG. 17, the installation regions of the four outer walls 71 (i.e., a pair of upper and lower transverse outer walls 71a extending transversely, and a pair of left and right longitudinal outer walls 71b extending longitudinally) on the second floor plan, the installation regions of multiple transverse boundary walls 72 arranged inside the four outer walls 71 and along the transverse direction, and the installation regions of multiple longitudinal boundary walls arranged inside the four outer walls 71 and along the longitudinal direction are identified. Note that in FIG. 17, in order to clearly explain the document integration step 44, one of the transverse boundary walls 72 is defined as a target transverse boundary wall 72a, which is a transverse boundary wall that is a target of description on association.

In this case, the document integration unit of the application server 12 identifies, by means of the matching unit of the document integration unit, in the drawing image data of the second floor plan view shown in FIG. 17, regarding the target transverse boundary wall 72a, on the basis of the installation regions of the outer wall 71 and the target transverse boundary wall 72a as well as at least one attribute data (preferably, multiple attribute data) assigned to the target transverse boundary wall 72a in the attribute assignment step 43, the target transverse boundary wall 72a. For example, in the present example, the floor number on which the target transverse boundary wall 72a is installed (e.g., the position in the Z-axis direction) and the relative position and orientation of the target transverse boundary wall 72a with respect to the four outer walls (position and orientation in the X-axis and Y-axis directions) are identified.

Specifically, the matching unit of the document integration unit can identify that the target transverse boundary wall 72a shown in FIG. 17 is “installed at a position along Y2-line (the second wall from the bottom)” on the basis of the distance 73 from the upper and lower transverse outer walls 71a, and that the target transverse boundary wall 72a is “installed at a position between X2-line and X3-line (the position between the second wall from the bottom and the third wall from the bottom)” on the basis of the separation distance 74 of the left and right longitudinal outer walls 71b, by comparing the installation regions of the four outer walls with the installation region ofthe target transverse boundary wall 72a.

Additionally, the matching unit of the document integration unit can acquire, as for the target transverse boundary wall 72a whose installation region was identified in the identification step 42, in terms of the drawing image data of FIG. 3, from the result obtained by performing natural language processing for the text information read in the attribute assignment step 43, for example, the attribute data of “installed on the second floor” on the basis of the text information (not shown) of “the second floor plan view” of the drawing name shown in FIG. 3, the attribute data of “disposed on Y2-line” on the basis of the text information of “Y2” on the left side of FIG. 13, the attribute data of “disposed between X2-line and X3-line” on the basis of the text information of “X2” and “X3” on the lower side of FIG. 13, and the attribute data of “the length of the transverse boundary wall is 10,500” on the basis of the text information of “10,500” between “X2” and “X3”.

Therefore, on the basis of these attribute data, the document integration unit can identify that the target transverse boundary wall 72a is “installed on the second floor”, “installed at a position along Y2-line”, “installed between X2-line and X3-line”, and “the length of the transverse boundary wall is 10,500”.

On the other hand, by performing the identification step 42 for the drawing image data of FIG. 5 using the wall learning model, the installation regions of the four outer walls 81 (i.e., a pair of upper and lower transverse outer walls 81a extending transversely, and a pair of left and right longitudinal outer walls 81b extending longitudinally) in the Y2-line sectional view, as shown in FIG. 18, the installation regions of the multiple transverse boundary walls 82 arranged inside the four outer walls 81 and along the transverse direction, and the installation regions of the multiple longitudinal boundary walls arranged inside the four outer walls and along the longitudinal direction are identified. Note that in FIG. 18, in order to clearly explain the document integration step 44, one of the transverse boundary walls 82 is defined as a target transverse boundary wall 82a, which is a target transverse boundary wall in the description on the association.

In this case, the matching unit of the document integration unit identifies, in the drawing image data of the Y2-line sectional view shown in FIG. 18, regarding the target transverse boundary wall 82a of FIG. 18, on the basis of the installation regions of the outer wall 81 and the target transverse boundary wall 82a as well as at least one attribute data (preferably, multiple attribute data) assigned to the target transverse boundary wall 82a in the attribute assignment step 43, the target transverse boundary wall 82a.

Specifically, by comparing the installation region of the four outer walls 81 with the installation region of the target transverse boundary wall 82a shown in FIG. 18, the matching unit can identify that the target transverse boundary wall 82a is “installed on the second floor” on the basis of the separation distance 83 of the upper and lower transverse outer walls 81a, and that the target transverse boundary wall 82a is “installed between X2-line and X3-line” on the basis of the separation distance 84 of the left and right longitudinal outer walls 81b.

Additionally, the matching unit can acquire, for the target transverse boundary wall 82a identified in the identification step 42, in terms of the drawing image data of FIG. 5, from the result obtained by performing natural language processing for the text information read in the attribute assignment step 43, for example, the attribute data of “installed along Y2-line” on the basis of the text information of “Y2-line” of the drawing name shown in FIG. 5, the attribute data of “installed on the second floor” on the basis of the text information of “2FL” on the left side of FIG. 13, the attribute data of “disposed between X2-line and X3-line” on the basis of the text information of “X2” and “X3” on the lower side of FIG. 13, and the attribute data of “the length of the transverse boundary wall is 10,500” on the basis of the text information of “10,500” between “X2” and “X3”. Therefore, on the basis of these attribute data, the matching unit can identify that the target transverse boundary wall 82a is “installed on the second floor”, “installed at a position along Y2-line”, “installed between X2-line and X3-line”, and “the length of the transverse boundary wall is 10,500”.

Then, from the items identified for the target transverse boundary wall 72a in the drawing image data of the second floor plan view in FIG. 3 and the items identified for the target transverse boundary wall 82a in the drawing image data of the two sectional views in FIG. 5, the matching unit determines that the target transverse boundary wall 72a shown in the drawing image data of the second floor plan view in FIG. 3 and the target transverse boundary wall 82a shown in the drawing image data of the two sectional views in FIG. 5 are the same transverse boundary wall, and as a result, the two target transverse boundary walls 72a, 82a are matched between FIG. 3 and FIG. 5.

Additionally, the matching unit performs processing similar to that for the target transverse boundary walls 72a and 82a described above for all outer walls and boundary walls shown in the drawing image data of FIGS. 3 and 5 respectively, to determine whether each outer wall 71 and each boundary wall shown in the drawing image data of FIG. 3 and each outer wall 81 and each boundary wall shown in the drawing image data of FIG. 5 are the same wall, and matches those determined to be the same wall between FIG. 3 and FIG. 5.

Thereafter, the document integration unit uses the image data integration unit to integrate the drawing image data of FIG. 3 with the drawing image data of FIG. 5, and associate the matched walls (outer walls and boundary walls) with each other, for example, if the matched walls between the drawing image data of FIG. 3 and the drawing image data of FIG. 5 account for 30% or more of the total walls, preferably 50% or more, and particularly preferably 70% or more.

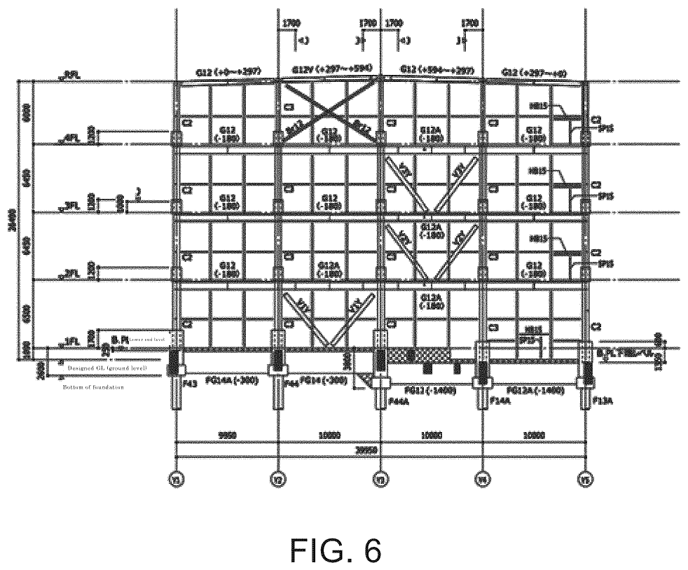

The document integration unit (matching unit and image data integration unit) of the application server 12 performs the processing performed between FIG. 3 and FIG. 5 as described above, between FIG. 2 and FIG. 4, between FIG. 2 and FIG. 5, between FIG. 2 and FIG. 6, between FIG. 3 and FIG. 4, and between FIG. 3 and FIG. 6, thereby integrating drawing image data and associating components (e.g., walls) between construction drawings.

Additionally, the document integration unit of the application server 12 can integrate the drawing image data of FIGS. 7-9 by matching and associating the steel column 55 and/or beams 61, 62 identified as construction elements in the identification step 42 with the corresponding drawing image data on the basis of their installation regions and attribute data, for example, for the steel column detail view of FIG. 7, the beam detail view of FIG. 8, and the steel column section list of FIG. 9, in the same way as the case of integrating the drawing image data of FIGS. 2-6.

As described above, the document integration unit of the present example performs matching by determining whether all construction elements identified in the identification step 42 of the drawing image data of FIGS. 2-9 are the same construction elements between two or more drawing image data, and integrates the drawing image data and associates the components between two or more construction drawings.

Furthermore, in the document integration unit of the present example, when the modifications (the changes, addition, deletion, etc. of construction elements) are made in one or more construction drawings for version update due to a change in the design of a building (for example, when the drawing image data shown in FIG. 17 is upgraded to the drawing image data shown in FIG. 19), it is possible to integrate the drawing image data and associate components (walls) between the construction drawings before the upgrade and the construction drawings after the upgrade by performing the processing performed between FIG. 3 and FIG. 5 as described above.

Additionally, construction drawings may include, for example errors, or when construction drawings are revised, the uncorrected parts may remain, and in this case, incorrect text information may be included in the construction drawings. In this case, when attribute data are assigned to each construction element from the text information in the attribute assignment step 43 described above, incorrect attribute data are assigned to construction elements containing errors or uncorrected parts.

In contrast, in the document integration unit of the present example, the image data integration unit integrates the drawing image data of at least two construction drawings, and then the comparison and confirmation unit compares the attribute data of the construction elements (corresponding construction elements) and matches between the at least two integrated drawing image data to confirm the consistency in the attribute data. At this time, if the aforementioned incorrect attribute data are assigned to the construction element, the comparison and confirmation unit will detect that the content of the corresponding attribute data between the two drawing image data is different from that of the other, and thereby the inconsistent attribute data between the two drawing image data are confirmed.

Furthermore, the document integration unit identifies construction elements with inconsistent attribute data confirmed by the comparison and confirmation unit between at least two integrated document image data, and notifies the user by means of the inconsistency notification unit of the document integration unit. For example, in the present example, the inconsistency notification unit of the document integration unit can identify construction elements with at least a part of the attribute data being inconsistent, and perform attribute inconsistency warning for warning that the content of the corresponding attribute data of the construction elements are different between two or more document image data (warning step 45).

The attribute inconsistency warning by the inconsistency notification unit can include displaying the content of the inconsistency in the attribute data in the document image data of the design document (particularly, the drawing image data of the construction drawing) displayed on the image display unit, and/or creating and sending an inquiry email with the content of the inconsistency in the attribute data.

Additionally, the document integration unit of the present example can refer to the construction-related laws and regulations stored in the database 13 in a laws-and-regulations warning unit for issuing a warning of non-compliance with laws and regulations when the construction elements identified in the drawing image data and the attribute data assigned to the construction elements were viewed in the light of construction-related laws and regulations and the part non-compliant with the construction-related laws and regulations was confirmed. (the warning step 45).

Thereafter, in the application server 12, the drawing image data of FIGS. 2-9 with the integration of drawing image data and the association of components are sent to the web application of the user terminal 30 via the web server 11. Additionally, when the document integration unit performs at least one of the warning of attribute inconsistency and the warning of non-compliance with laws and regulations, the content of warning is also sent from the application server 12 to the web application.

Then, in the web application of the user terminal 30 that received the drawing image data of FIGS. 2-9 from the application server 12, the image display unit of the web application performs an image display step 46 in which at least one of the received drawing image data is displayed in a state where the construction elements (e.g., walls, steel columns, etc.) subjected to association in the aforementioned document integration step 44 are associated with the construction elements of other drawing image data.

For example, in the image display system 1 of the present example, when the web application of the user terminal 30 displays the drawing image data of FIG. 3 in the image display step 46, the target transverse boundary walls 72a shown in FIGS. 17 and 18 are associated with each other, so when the image display unit displays the drawing image data of FIG. 3 on the screen of the user terminal 30, it displays the target transverse boundary wall 72a in a different color (for example, red) and links it to the target transverse boundary wall 72a shown in the drawing image data of FIG. 5.

Thereby, a user looking at the screen of the user terminal 30 can know that when he or she clicks on the target transverse boundary wall 72a on the drawing image data of FIG. 3 displayed on the screen, there is a target transverse boundary wall 72a corresponding to other drawing image data. Additionally, for example, when the user double-clicks on the target transverse boundary wall 72a on the drawing image data of FIG. 3 displayed on the screen of the user terminal 30, the image display unit of the web application can display the drawing image data of FIG. 5 on the screen and display the target transverse boundary wall 72a on the drawing image data of FIG. 5 in another color (for example, red).

As a result, the user can easily know that the target transverse boundary wall 72a on the drawing image data of FIG. 3 and the target transverse boundary wall 72a on the drawing image data of FIG. 5 correspond to each other (are the same). Therefore, even if the variety and the number of construction drawings increase in a construction project, the consistency in construction elements such as walls and steel columns can be easily maintained between different construction drawings, and the contradictions or inconsistencies between construction drawings can be prevented or suppressed.

Additionally, for example, when the document integration unit of the application server 12 performs an attribute inconsistency warning in the warning step 45, the image display unit of the web application can receive the attribute inconsistency warning, and display the content of inconsistency in attribute data if the drawing image data displayed on the screen include a construction element that will receive the warning. Specifically, a construction element assigned with inconsistent attribute data can be displayed prominently by, for example, flashing the construction element or displaying a caution mark on the construction element.

Thereby, if there are, for example any errors or uncorrected parts in a construction drawing, the user can know that the drawing image data includes a construction element with attribute data different from that of other drawing image data, and further, by comparing the drawing image data with other drawing image data, the user can easily know the errors or uncorrected parts and take corresponding action.

Furthermore, the image display unit of the present example can display attribute data assigned to a construction element in association with the construction element. For example, when the drawing image data of FIG. 3 is displayed on the screen of the user terminal 30 and the user double-clicks on the target transverse boundary wall 72a shown in FIG. 17, the image display unit of the web application can display at least one of the attribute data received from the application server 12 for the target transverse boundary wall 72a, such as “installed on the second floor”, “disposed on Y2-line”, “disposed between X2-line and X3-line” and “the length of the transverse boundary wall is 10,500” on the right or left edge of the screen of the user terminal 30, for example in the form of a list. Thereby, the user can easily know the specific information on the target transverse boundary wall 72a.

Furthermore, for example, when the document integration unit of the application server 12 issues a warning of non-compliance with laws and regulations in the warning step 45, and the drawing image data displayed on the screen include a construction element that will receive the warning, the image display unit of the web application can prominently display the construction element by, for example flashing the construction element or displaying a caution mark on the construction element. Thereby, the user can easily know that the drawing image data include parts non-compliant with construction-related laws and regulations, and take corresponding action.

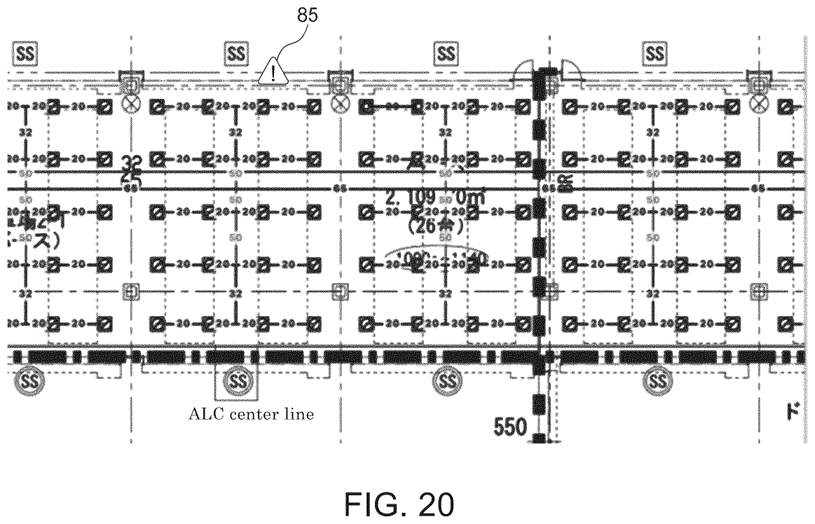

For example, FIG. 20 shows drawing image data of a fire-extinguishing equipment diagram. By performing the aforementioned identification step 42 and attribute assignment step 43 for the drawing image data of the fire-extinguishing equipment diagram, the installation region of the sprinkler head of the fire-extinguishing equipment is identified, and the numerical values, scale information, etc. shown in the drawing image data are assigned to the sprinkler head as attribute data. Thereafter, in a document integration unit or a calculation unit disposed in the application server 12, the distance between adjacent sprinkler heads can calculated from, for example the installation region of sprinkler head and the scale information of attribute data.

Thereafter, the law-and-regulation warning unit of the document integration unit refers to construction-related laws and regulations stored in a database 13, and compares the calculated distance between sprinkler heads with the provisions of the construction-related laws and regulations, and if any part is confirmed to be non-compliant with the construction-related laws and regulations, a warning of non-compliance with laws and regulations will be issued. Thereby, when the image display unit of the web application displays the drawing image data of the fire-extinguishing equipment diagram on the screen of the user terminal 30 (see FIG. 20), it can perform processing for a sprinkler head determined to be non-compliant with laws and regulations according to the warning of non-compliance with laws and regulations, such as flashing the sprinkler head or attaching a caution mark 85 to the sprinkler head.

Furthermore, as for the application server 12 or the web application of the present example, in the document integration unit of the application server 12, when a warning of attribute inconsistency or a warning of non-compliance with laws and regulations is issued, an inquiry e-mail with the content of warning can be automatically created, and the created e-mail can be automatically sent to a pre-specified e-mail address.

As the method for automatically creating the inquiry e-mail with the content of warning, for example, the image display system of the present example can utilize, for example a method in which the required items in parentheses are entered in a pre-set template such as “the <construction element name> on the page <page number> of the case <case name> detected <attribute data>, but a problem of <warning content> occurred, so please check” to create an inquiry e-mail, depending on the content of the warning, or a method in which an inquiry e-mail is created by executing a command prompt using a large-scale language model of construction field.

As described above, in the document integration unit, when a warning of attribute inconsistency or a warning of non-compliance with laws and regulations is issued, an inquiry e-mail with the content of warning can be automatically sent to a pre-specified e-mail address, and thereby the user can understand more appropriately the content of the warning of attribute inconsistency or the warning of non-compliance with laws and regulations, and take corresponding action.

### Automatic Calculation Method Using Automatic Calculation System

According to the present example, an automatic calculation system and an automatic calculation method are provided that can automatically calculate at least a part of the construction cost utilizing some of the functions of the aforementioned image display system 1. The application server 12 of the aforementioned image display system 1 is provided with an identification unit that identifies the type and installation region of construction elements described in the drawing image data, and an attribute assignment unit that assigns attribute data generated from text information to the identified construction elements.

The automatic calculation system of the present example includes a calculation unit that automatically calculates the construction cost using the installation region of the construction element identified by the identification unit of the image display system 1 and information such as type, size (length), sectional shape, scale information, etc. assigned to the construction element by the attribute assignment unit of the image display system 1. The automatic calculation system with this calculation unit is included in the application server 12 shown in FIG. 1.

The calculation unit of this automatic calculation system can acquire information on the installation region ofconstruction elements such as walls and steel columns from the identification unit of the application server 12. Additionally, information such as type, size (length), sectional shape and scale information assigned to the construction element can be acquired from the attribute assigning unit. The calculation unit of the automatic calculation system that acquired the information can also obtain the actual size (length) of the construction element by, for example calculating the ratio of the pixel spacing on the drawing image data and the actual size (length) of the construction element.

Additionally, in the present example, the calculation unit of the automatic calculation system is configured to be able to acquire the price of a construction element by, for example receiving it from the input means of the user terminal 30, or by referring to the database 13 of the management server 10 (for example, by referring to the content of a catalog etc. stored in the database 13).

Thereby, the calculation unit of the automatic calculation system can automatically calculate the cost of construction element on the basis of the actual size (length) of the construction element and the acquired price of the construction element, and display the cost on the screen of the user terminal 30. For example, when a construction estimator performs estimation service, the calculation unit can automatically calculate the costs of the construction elements shown in the construction drawings (preferably the costs of all construction elements) by importing document image data including drawing image data of all construction drawings created at that time into the image display system 1 of the present example, and display the calculated costs on the screen of the user terminal 30. Therefore, the calculation results (the costs of construction elements) of the automatic calculation system displayed on the screen of the user terminal 30 can be effectively utilized in the estimation service of the construction estimator. That is, at least a part of operation of estimation service (estimation operation) performed by a construction estimator in a construction project can be performed automatically and precisely by using the automatic calculation system of the present example.

Therefore, the automatic calculation system of the present example can reduce the time and labor required for the operation of the construction estimator, thereby significantly reducing the workload in the estimation service. Furthermore, as a result, the quality of estimation service can be improved, and the need for outsourcing estimation service can be reduced. Additionally, it can be expected to contribute to solving the long-standing concern of the shortage of construction estimators and the limited options for construction work that companies can undertake.

Note that the present invention is not limited to the aforementioned embodiments, and various modifications are possible as long as they have substantially the same configuration as that described in the claims of the present invention and provide similar effects. For example, in the image display system 1 and the automatic calculation system of the aforementioned examples, a case is described in which a logistics center is constructed as a building. However, in the present invention, the buildings shown in the multiple construction drawings are not limited, and the buildings to be constructed include various buildings such as apartment buildings, detached houses, schools, stores and entertainment venues.

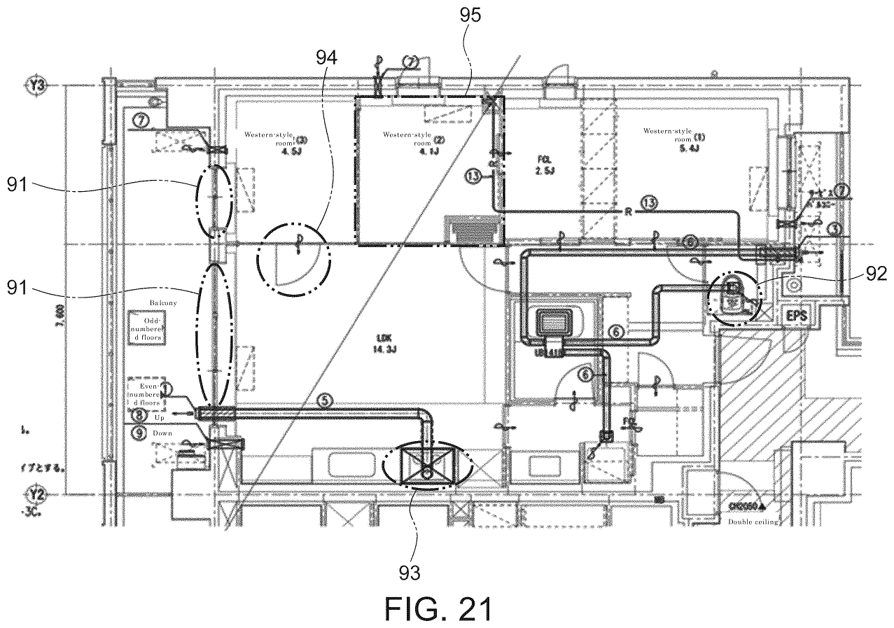

For example, when an apartment building is constructed as a building, in addition to the general drawing, design drawing, structural drawing and equipment drawing for the entire apartment building, the plan view and equipment diagram for each dwelling unit are also used. In the construction project of an apartment building, for example, when a plan view of a dwelling unit such as that shown in FIG. 21 is used, in the image display system 1 of the present invention, in the data acquisition unit (data acquisition step 41), the drawing image data of plan view of dwelling unit are acquired, and the installation regions of construction elements such as a wall (an outer wall, a boundary wall, etc.), a window 91, a toilet 92, a stove 93, a door 94, piping, etc. can be identified by the identification unit (identification step 42) of the image display system 1, and the text information described in the plan view of the dwelling unit and other construction drawings is read by the attribute assignment unit of the image display system 1 to generate the attribute data for each construction element and assign the generated attribute data to each construction element.

Thereby, as shown in FIG. 21, the user can easily recognize the wall (outer wall, boundary walls, etc.), the window 91, the toilet 92, the stove 93, the door 94, the pipes, etc. on the drawing image data displayed on the screen of the user terminal 30, and can easily confirm the various attribute data assigned to each construction element.

Furthermore, the image display system 1 of the present invention can identify the wall installation region and room installation region (arrangement) as construction elements in the plan view of the dwelling unit, and can also determine the layout of the dwelling unit by reading text information such as “LDK”, “Western-style room” and “FCL” described in the plan view and performing natural language processing. Thereby, for example, when the drawing image data of a plan view of a dwelling unit are displayed on the screen of user terminal 30, each room such as room 95 can be displayed in a different color depending on whether it is an “LDK”, “Western-style room” or “FCL”.

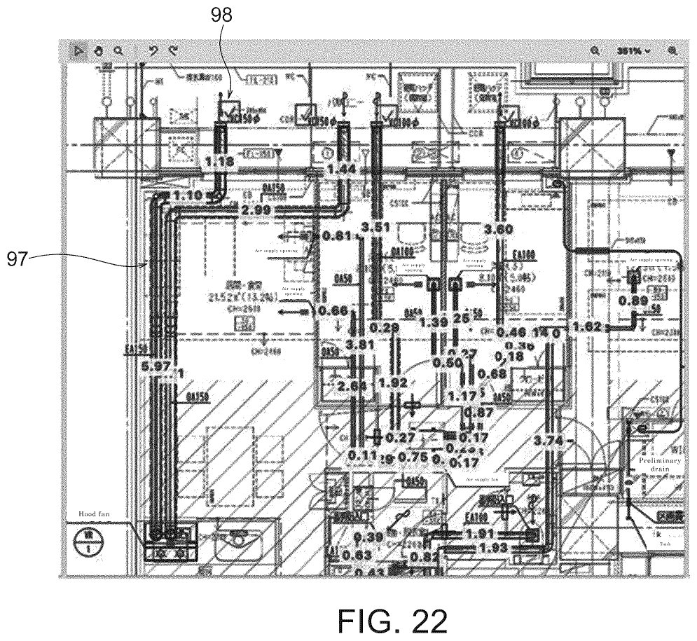

Additionally, when an apartment building is constructed, the data acquisition unit of the image display system 1 acquires, for example the drawing image data of an air-conditioning and ventilating equipment diagram of a dwelling unit shown in FIG. 22, and the identification unit of the image display system 1 can identify the installation regions of construction elements such as the a duct 97 and a vent cap 98 of the dwelling unit. Additionally, the attribute assignment unit of the image display system 1 can assign information such as type, size (length), sectional shape, scale information, etc. to each construction element.

Thereby, the user can easily confirm the length and sectional shape of the duct 97, the size of the vent cap 98, etc. by looking at the content displayed by the image display system 1 of the present invention. Additionally, by using the automatic calculation system of the present example, it is possible to automatically calculate the costs of the air-conditioning and ventilating equipment with the duct 97, the vent cap 98, etc., and display them on the screen of the user terminal 30.

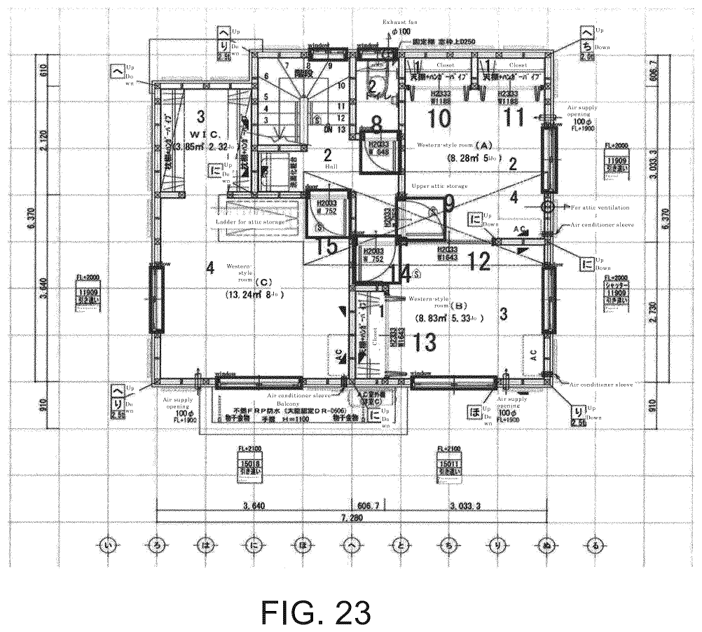

Additionally, for example, when a detached house is constructed as a building, the construction drawings used for the construction of the detached house include, for example, a plan view of FIG. 23 showing the layout of the detached house, an elevation view of the detached house viewed from directions such as east, west, south and north. In the image display system 1 of the present invention, when the drawing image data of a plan view, an elevation view, etc. of such detached house are acquired by the data acquisition unit, an identification step 42 is performed for the drawing image data of the plan view shown in FIG. 23.

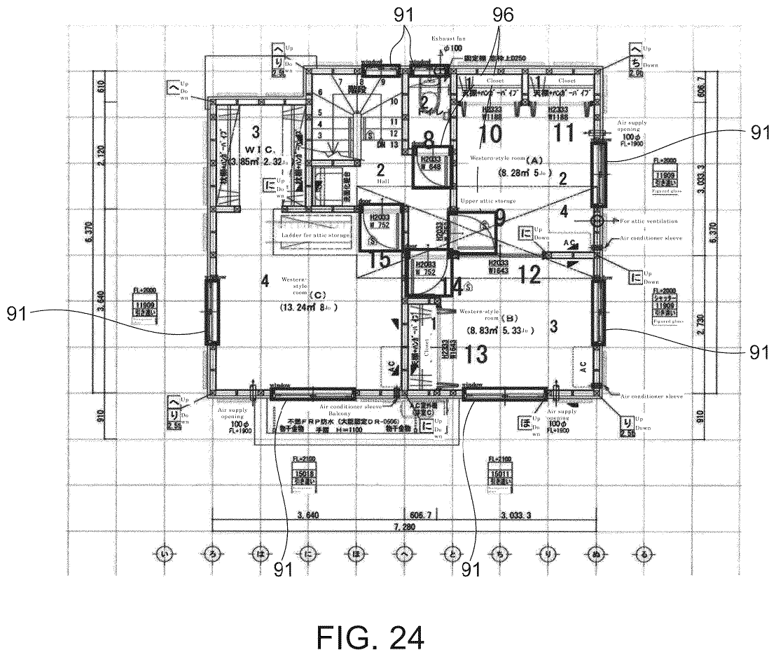

Thereby, as shown in FIG. 24, the installation regions of construction elements such as a wall (an outer wall and a boundary wall), a window 91, a door 96, toilets, closets, rooms, stairs, balconies and entrances can be identified. Additionally, by performing the attribute assignment step 43, the attribute data such as type, size, material, orientation and model number can be assigned to each construction element.

Additionally, by performing the identification step 42 for the drawing image data (not shown) of elevation views of the detached house, the installation regions of construction elements such as walls (outer walls), windows, balconies and entrances described in each elevation view can be identified, and by performing attribute assignment step 43, the attribute data such as type, size, material, orientation and model number can be assigned to each construction element shown in the elevation views.

Thereafter, in the image display system 1, a document integration step 44 is performed in which the drawing image data of plan view of detached house and the drawing image data of elevation view of the detached house are integrated on the basis of the installation regions of the construction elements and the attribute data of the construction elements. Thereby, for example, the walls, the window 91, the balconies, the entrances, etc. shown in the drawing image data of a plan view can be associated with the walls, the windows, the balconies, the entrances, etc. shown in the drawing image data of an elevation view, so as to integrate the drawing image data of the plan view and the drawing image data of the elevation view.

Thereby, when the image display unit of the image display system 1 displays the drawing image data of plan view on the screen of the user terminal 30, the drawing image data of plan view can be displayed on the screen in a state where the walls, the window 91, the balconies, the entrances, etc. subjected to association in the document integration step 44 are associated (linked) with the corresponding construction elements of the drawing image data of elevation view. Additionally, when the user double-clicks, for example, a window in the drawing image data displayed on the screen, the attribute data of the window can also be displayed in the form of a list.

Additionally, a case is described where in the image display system 1 and automatic calculation system of the aforementioned example, the document image data of the design documents acquired by the data acquisition unit are the drawing image data (document image data) of the construction drawings shown by FIGS. 2-9, 19, 20, etc. However, in the present invention, the document image data acquired by the data acquisition unit may further include the document image data of specifications and the document image data of construction plans as long as the drawing image data of at least one construction drawing are included. By acquiring the document image data of specifications and construction plans, it becomes possible to obtain more attribute data for the construction elements shown in the drawing image data of the construction drawings.

### REFERENCE TO THE NUMERALS

1 image display system
10 management server
11 web server
12 application server
13 database (database server)
14 serving server
15 storage
20 network
30 user terminal (client terminal)
31 web browser
41 the step of data acquisition
42 the step of identification
43 the step of attribute assignment
44 the step of document integration
45 the step of processing for warning
46 the step of image display
51 outer wall
52 longitudinal boundary wall
53 transverse boundary wall
55 steel column
56, 57 text information
61 longitudinal beam
62 transverse beam
63 text information
65, 66 text information
67 text information
70 wall
71 outer wall
71a transverse outer wall
71b longitudinal outer wall
72 transverse boundary wall
72a target transverse boundary wall
73, 74 separation distance
80 wall
81 outer wall
81a transverse outer wall
81b longitudinal outer wall
82 transverse boundary wall
82a target transverse boundary wall
83, 84 separation distance
85 caution mark
91 window
92 toilet
93 stove
94 door
95 room
96 door
97 duct
98 vent cap

1. An image display system for displaying, on a screen, document image data of design documents comprising at least one construction drawing used in construction, wherein the image display system comprises:
a data acquisition unit for acquiring the document image data of each of the plurality of design documents comprising the at least one construction drawing;
an identification unit for identifying the installation region of at least one construction element described in the acquired document image data of the construction drawing;
an attribute assignment unit for reading text information described in each of the document image data to generate attribute data and assigning the generated attribute data to the construction elements whose installation regions were identified by the identification unit;
a document integration unit for integrating the document image data of the plurality of design documents comprising the at least one construction drawing by matching and associating, between at least two document image data, on the basis of at least one of the installation region of each of the construction elements and the attribute data assigned to each of the construction elements, the construction elements whose installation regions were identified by the identification unit; and
an image display unit for displaying on the screen the document image data of the at least one construction drawing comprised in the document image data integrated by the document integration unit by associating the construction elements described in the document image data with the construction elements described in other document image data.

2. The image display system according to claim 1, wherein the attribute data of the construction elements comprise at least one of the type, shape, size, material, position and orientation of the construction elements.

3. The image display system according to claim 1, wherein the identification unit comprises an array data generation unit for generating array data comprising image information from the document image data of the construction drawing acquired by the data acquisition unit; and an element identification unit for identifying the types and the installation regions of the construction elements using a machine learning model generated by machine learning with the array data of the document image data of the construction drawing as input and binary data indicating the installation regions of the construction elements in the array data as output.

4. The image display system according to claim 1, wherein the attribute assignment unit comprises a reading unit for reading text information from the document image data by means of OCR processing; and a natural language processing unit for performing natural language processing for the read text information to generate the attribute data.

5. The image display system according to claim 1, wherein the image display unit displays the attribute data assigned to the construction elements in association with the construction elements.

6. The image display system according to claim 1, having a database for storing at least one of information about a building to be constructed and information about each of the construction elements used in the building, wherein the attribute assignment unit refers to the information stored in the database when assigning the attribute data to the construction elements.

7. The image display system according to claim 1, wherein if modifications of the construction elements are made in the design documents, the data acquisition unit acquires the document image data of the design documents before the modifications of the construction elements and the document image data of the design documents after the modifications of the construction elements,
the document integration unit integrates the document image data of the design documents before the modifications and the document image data of the design documents after the modifications of the construction elements,
and the image display unit displays the document image data of the design documents before the modifications and the document image data of the design documents after the modifications of the construction elements.

8. The image display system according to claim 1, wherein the document integration unit comprises a matching unit for comparing the attribute data of corresponding construction elements between the at least two document image data and matching the construction elements; an image data integration unit for integrating the at least two document image data with the matching of the construction elements confirmed; a comparison and confirmation unit for comparing the attribute data of the corresponding construction elements between the integrated document image data and confirming the consistency of the attribute data; and an inconsistency notification unit for identifying the construction elements with the inconsistent attribute data confirmed in the comparison and confirmation unit and notifying a user.

9. The image display system according to claim 8, wherein the inconsistency notification unit performs processing for displaying, in the document image data of the design documents displayed by the image display unit, the content of inconsistency in the attribute data, and/or processing for creating and sending an inquiry e-mail with the content of the inconsistency in the attribute data.

10. An automatic calculation system, wherein the automatic calculation system automatically calculates at least a part of the cost of the construction, utilizing the installation regions of the construction elements identified by the image display system according to claim 1 and the attribute data assigned to the construction elements.

11. An image display method for displaying, on a screen, document image data of design documents comprising at least one construction drawing used in construction, using the image display system, wherein the image display method comprises
a data acquisition step in which the data acquisition unit of the image display system acquires the document image data of each of the plurality of design documents comprising the at least one construction drawing;
an identification step in which the identification unit of the image display system identifies the installation region of at least one construction element described in the acquired document image data of the construction drawing;
an attribute assignment step in which the attribute assignment unit of the image display system reads text information described in each of the document image data to generate attribute data and assigns the generated attribute data to the construction elements whose installation regions were identified in the identification step;
a document integration step in which the document integration unit of the image display system integrates the document image data of the plurality of design documents comprising the at least one construction drawing by matching and associating, between at least two document image data, on the basis of at least one of the installation region of each of the construction elements and the attribute data assigned to each of the construction elements, the construction elements whose installation regions were identified in the identification step; and
an image display step in which the image display unit of the image display system displays on the screen the document image data of the at least one construction drawing comprised in the document image data integrated in the document integration step by associating the construction elements described in the document image data with the construction elements described in other document image data.

12. The image display method according to claim 11, wherein the attribute assignment step comprises the attribute assignment unit's reading text information from the document image data by means of OCR processing and performing natural language processing for the read text information to generate the attribute data.

13. The image display method according to claim 11, wherein the image display step comprises the image display unit's displaying the attribute data assigned to the construction elements in association with the construction elements.

14. The image display method according to claim 11, wherein if modifications of the construction elements are made in the design documents, the data acquisition step comprises the data acquisition unit's acquiring the document image data of the design documents before the modifications of the construction elements and the document image data of the design documents after the modifications of the construction elements,
the document integration step comprises the document integration unit's integrating the document image data of the design documents before the modifications and the document image data of the design documents after the modifications of the construction elements,
and the image display step comprises the image display unit's displaying the document image data of the design documents before the modifications and the document image data of the design documents after the modifications of the construction elements.

15. The image display method according to claim 11, wherein the document integration step comprises the document integration unit's comparing the attribute data of the corresponding construction elements between the at least two document image data to match the construction elements, integrating the at least two document image data with the matching of the construction elements confirmed, comparing the attribute data of the corresponding construction elements between the integrated document image data to confirm the consistency of the attribute data, and identifying the construction elements with the inconsistent attribute data confirmed through comparison of the attribute data and notifying a user.

16. The image display method according to claim 15, wherein the document integration step comprises, upon identification of the construction elements with inconsistency in the attribute data, performing processing for displaying, in the document image data of the design documents displayed by the image display unit, the content of inconsistency in the attribute data, and/or performing processing for creating and sending an inquiry e-mail with the content of the inconsistency in the attribute data.

17. An automatic calculation method, wherein at least a part of the cost of the construction is automatically calculated, utilizing the installation regions of the construction elements identified by the image display method according to claim 11 and the attribute data assigned to the construction elements.
